(19) United States
(12) Patent Application Publication
(10) Pub. No.: US 2014/0002320 A1
(43) Pub. Date: Jan. 2, 2014

(54) ANTENNA APPARATUS OPERABLE IN DUALBANDS WITH SMALL SIZE

(71) Applicants: Kenichi Asanuma, Kyoto (JP); Atsushi Yamamoto, Kyoto (JP); Tsutomu Sakata, Osaka (JP)

(72) Inventors: Kenichi Asanuma, Kyoto (JP); Atsushi Yamamoto, Kyoto (JP); Tsutomu Sakata, Osaka (JP)

(21) Appl. No.: 14/003,588

(22) PCT Filed: Jan. 26, 2012
(86) PCT No.: PCT/JP2012/000500

§ 371 Date: Sep. 6, 2013

(30) Foreign Application Priority Data
Mar. 16, 2011 (JP) 2011-057555

(51) Int. Cl. H01Q 5/01

(52) U.S. Cl. CPC H01Q 5/01
USPC 343/749

(57) ABSTRACT

A radiator is provided with a looped radiation conductor, a capacitor, an inductor, and a feed point provided on the radiation conductor. The radiator is configured such that: a first portion of the radiator including the inductor and the capacitor and being along the loop of the radiation conductor resonates at a first frequency; and a second portion of the radiator including a section along the loop of the radiation conductor resonates at a second frequency higher than the first frequency, the section including the capacitor but not including the inductor, and the section extending between a feed point and the inductor.

### TECHNICAL FIELD

The present invention relates to an antenna apparatus mainly for use in mobile communication such as mobile phones, and relates to a wireless communication apparatus provided with such an antenna apparatus.

### BACKGROUND ART

The size and thickness of portable wireless communication apparatuses, such as mobile phones, have been rapidly reduced. In addition, the portable wireless communication apparatuses have been transformed from apparatuses to be used only as conventional telephones, to data terminals for transmitting and receiving electronic mails and for browsing web pages of WWW (World Wide Web), etc. Further, since the amount of information to be handled has increased from that of conventional audio and text information to that of pictures and videos, a further improvement in communication quality is required. In such circumstances, there are proposed a multiband antenna apparatus and a compact antenna apparatus, supporting a plurality of wireless communication schemes. Further, there is proposed an array antenna apparatus capable of reducing electromagnetic coupling among antenna apparatuses each corresponding to the above mentioned one, and thus, performing high-speed wireless communication.

According to an invention of Patent Literature 1, a two-frequency antenna is characterized by having: a feeder, an inner radiation element connected to the feeder, and an outer radiation element, all of which are printed on a first surface of a dielectric board; an inductor formed in a gap between the inner radiation element and the outer radiation element printed on the first surface of the dielectric board to connect the two radiation elements; a feeder, an inner radiation element connected to the feeder, and an outer radiation element, all of which are printed on a second surface of the dielectric board; and an inductor formed in a gap between the inner radiation element and the outer radiation element printed on the second surface of the dielectric board to connect the two radiation elements. The two-frequency antenna of Patent Literature 1 is operable in multiple bands by forming a parallel resonant circuit from the inductor provided between the radiation elements and a capacitance between the radiation elements.

According to an invention of Patent Literature 2, a multiband antenna includes an antenna element having a first radiation element and a second radiation element connected to respective opposite ends of an LC parallel resonance circuit, and is characterized in that the LC parallel resonant circuit is constituted of self-resonance of an inductor itself. The multiband antenna of Patent Literature 2 is operable in multiple bands due to the LC parallel resonant circuit constituted of the self-resonance of the inductor of a whip antenna itself.

### CITATION LIST

### Patent Literature

Patent Literature 1: Japanese Patent Laid-open Publication No. 2001-185938
Patent Literature 2: Japanese Patent Laid-open Publication No. H11-055022
Patent Literature 3: Japanese Patent No. 4003077

### SUMMARY OF INVENTION

### Technical Problem

In recent years, there has been an increasing need to increase the data transmission rate on mobile phones, and thus, a next generation mobile phone standard, 3G-LTE (3rd Generation Partnership Project Long Term Evolution) has been studied. According to 3G-LTE, as a new technology for an increased wireless transmission rate, it is determined to use a MIMO (Multiple Input Multiple Output) antenna apparatus using a plurality of antennas to simultaneously transmit or receive radio signals of a plurality of channels by spatial division multiplexing. The MIMO antenna apparatus uses a plurality of antennas at each of a transmitter and a receiver, and spatially multiplexes data streams, thus increasing a transmission rate. Since the MIMO antenna apparatus uses the plurality of antennas so as to simultaneously operate at the same frequency, electromagnetic coupling between the antennas becomes very strong under circumstances where the antennas are disposed close to each other within a small-sized mobile phone. When the electromagnetic coupling between the antennas becomes strong, the radiation efficiency of the antennas degrades. Therefore, received radio waves are weakened, resulting in a reduced transmission rate. Hence, it is necessary to provide an low coupling array antenna in which a plurality of antennas are disposed close to each other. In addition, in order to implement spatial division multiplexing, it is necessary for the MIMO antenna apparatus to simultaneously transmit or receive a plurality of radio signals having a low correlation therebetween, by using different radiation patterns, polarization characteristics, or the like. Furthermore, a technique for increasing the bandwidth of antennas is required in order to increase communication rate.

According to the two-frequency antenna of Patent Literature 1, if decreasing the low-band operating frequency, the size of the radiation elements should be increased. In addition, no contribution to radiation is made by slits between the inner radiation elements and the outer radiation elements.

According to the multiband antenna of Patent Literature 2, if the antenna is to operate in a low band, the element lengths of the radiation elements should be increased. In addition, no contribution to radiation is made by the LC parallel resonant circuit.

Therefore, it is desired to provide an antenna apparatus capable of achieving both multiband operation and size reduction.

An object of the present invention is to solve the above-described problems, and to provide an antenna apparatus capable of achieving both multiband operation and size reduction, and to provide a wireless communication apparatus provided with such an antenna apparatus.

### Solution to Problem

According to an antenna apparatus of a first aspect of the present invention, the antenna apparatus is provided with at least one radiator. Each of the at least one radiator is provided with: a looped radiation conductor; at least one capacitor inserted at at least one position along a loop of the radiation conductor; at least one inductor inserted at at least one position along the loop of the radiation conductor, the position of the inductor being different from the position of the capacitor; and a feed point provided on the radiation conductor. Each of the at least one radiator is configured such that: a first portion of the radiator including the inductor and the capacitor and being along the loop of the radiation conductor resonates at a first frequency; and a second portion of the radiator including a section along the loop of the radiation conductor resonates at a second frequency higher than the first frequency, the section including the capacitor but not including the inductor, and the section extending between the feed point and the inductor.

In the antenna apparatus, the radiation conductor includes a first radiation conductor and a second radiation conductor. The capacitor is formed by a capacitance formed between the first and second radiation conductors.

In the antenna apparatus, the inductor is made of a strip conductor.

In the antenna apparatus, the inductor is made of a meander conductor.

The antenna apparatus is further provided with a ground conductor.

In the antenna apparatus, the capacitor and the inductor of each of the at least one radiator are provided along the loop of the radiation conductor and at a portion where the radiation conductor and the ground conductor are close to each other. The feed point is provided between the capacitor and the inductor.

The antenna apparatus is provided with a printed circuit board, the printed circuit board provided with the ground conductor, and a feed line connected to the feed point. The radiator is formed on the printed circuit board.

The antenna apparatus is a dipole antenna including at least a pair of radiators.

The antenna apparatus is provided with a plurality of radiators. The plurality of radiators have a plurality of different first frequencies and a plurality of different second frequencies, respectively.

In the antenna apparatus, the radiation conductor is bent at at least one position.

The antenna apparatus is provided with a plurality of radiators connected to different signal sources.

The antenna apparatus is provided with a first radiator and a second radiator that have radiation conductors configured symmetrically with respect to a reference axis. Feed points of the first and second radiators are provided at positions symmetric with respect to the reference axis. The radiation conductors of the first and second radiators are shaped such that a distance between the first and second radiators gradually increases as a distance from the feed points of the first and second radiators along the reference axis increases.

The antenna apparatus is provided with a first radiator and a second radiator. Loops of radiation conductors of the first and second radiators are configured substantially symmetrically with respect to a reference axis. When proceeding along the symmetric loops of the radiation conductors of the first and second radiators in corresponding directions starting from the respective feed points, the first radiator is configured such that the feed point, the inductor, and the capacitor are located in this order, and the second radiator is configured such that the feed point, the capacitor, and the inductor are located in this order.

According to a wireless communication apparatus of a second aspect of the present invention, the antenna apparatus is provided with the antenna apparatus of the first aspect of the present invention.

### Advantageous Effects of Invention

According to the antenna apparatus of the present invention, it is possible to provide an antenna apparatus operable in multiple bands, while having a simple and small configuration. In addition, when the antenna apparatus of the present invention includes a plurality of radiators, the antenna apparatus has low coupling between antenna elements, and thus, is operable to simultaneously transmit or receive a plurality of radio signals. In addition, according to the present invention, it is possible to provide a wireless communication apparatus provided with such an antenna apparatus.

### BRIEF DESCRIPTION OF DRAWINGS

FIG. 1 is a schematic diagram showing an antenna apparatus according to a first embodiment of the present invention.

FIG. 2 is a diagram showing a current path for the case where the antenna apparatus of FIG. 1 operates at low-band resonance frequency f1.

FIG. 3 is a diagram showing a current path for the case where the antenna apparatus of FIG. 1 operates at high-band resonance frequency f2.

FIG. 4 is a diagram for illustrating a matching effect brought about by an inductor L1 and a capacitor C1 when the antenna apparatus of FIG. 1 operates at the low-band resonance frequency f1.

FIG. 5 is a diagram for illustrating a matching effect brought about by the inductor L1 and the capacitor C1 when the antenna apparatus of FIG. 1 operates at the high-band resonance frequency f2.

FIG. 6 is a schematic diagram showing the frequency characteristics of VSWR according to the antenna apparatus of FIG. 1.

FIG. 7 is a schematic diagram showing an antenna apparatus according to a first modified embodiment of the first embodiment of the present invention.

FIG. 8 is a diagram showing a current path for the case where the antenna apparatus of FIG. 7 operates at the low-band resonance frequency f1.

FIG. 9 is a diagram showing a current path for the case where the antenna apparatus of FIG. 7 operates at the high-band resonance frequency f2.

FIG. 10 is a schematic diagram showing the frequency characteristics of VSWR according to the antenna apparatus of FIG. 7.

FIG. 11 is a schematic diagram showing an antenna apparatus according to a second modified embodiment of the first embodiment of the present invention.

FIG. 12 is a diagram showing a current path for the case where the antenna apparatus of FIG. 11 operates at the low-band resonance frequency f1.

FIG. 13 is a diagram showing a current path for the case where the antenna apparatus of FIG. 11 operates at the high-band resonance frequency f2.

FIG. 14 is a schematic diagram showing the frequency characteristics of VSWR according to the antenna apparatus of FIG. 11.

FIG. 15 is a schematic diagram showing an antenna apparatus according to a third modified embodiment of the first embodiment of the present invention.

FIG. 16 is a schematic diagram showing an antenna apparatus according to a fourth modified embodiment of the first embodiment of the present invention.

FIG. 17 is a schematic diagram showing an antenna apparatus according to a fifth modified embodiment of the first embodiment of the present invention.

FIG. 18 is a schematic diagram showing an antenna apparatus according to a sixth modified embodiment of the first embodiment of the present invention.

FIG. 19 is a schematic diagram showing an antenna apparatus according to a seventh modified embodiment of the first embodiment of the present invention.

FIG. 20 is a schematic diagram showing an antenna apparatus according to an eighth modified embodiment of the first embodiment of the present invention.

FIG. 21 is a schematic diagram showing an antenna apparatus according to a ninth modified embodiment of the first embodiment of the present invention.

FIG. 22 is a schematic diagram showing an antenna apparatus according to a tenth modified embodiment of the first embodiment of the present invention.

FIG. 23 is a schematic diagram showing an antenna apparatus according to an eleventh modified embodiment of the first embodiment of the present invention.

FIG. 24 is a schematic diagram showing an antenna apparatus according to a twelfth modified embodiment of the first embodiment of the present invention.

FIG. 25 is a schematic diagram showing an antenna apparatus according to a thirteenth modified embodiment of the first embodiment of the present invention.

FIG. 26 is a schematic diagram showing an antenna apparatus according to a fourteenth modified embodiment of the first embodiment of the present invention.

FIG. 27 is a schematic diagram showing an antenna apparatus according to a fifteenth modified embodiment of the first embodiment of the present invention.

FIG. 28 is a schematic diagram showing an antenna apparatus according to a second embodiment of the present invention.

FIG. 29 is a schematic diagram showing an antenna apparatus according to a first modified embodiment of the second embodiment of the present invention.

FIG. 30 is a schematic diagram showing an antenna apparatus according to a comparison example.

FIG. 31 is a schematic diagram showing an antenna apparatus according to a second modified embodiment of the second embodiment of the present invention.

FIG. 32 is a diagram showing a current path for the case where the antenna apparatus of FIG. 28 operates at the low-band resonance frequency f1.

FIG. 33 is a diagram showing a current path for the case where the antenna apparatus of FIG. 28 operates at the high-band resonance frequency f2.

FIG. 34 is a diagram showing a current path for the case where the antenna apparatus of FIG. 31 operates at the low-band resonance frequency f1.

FIG. 35 is a diagram showing a current path for the case where the antenna apparatus of FIG. 31 operates at the high-band resonance frequency f2.

FIG. 36 is a schematic diagram showing an antenna apparatus according to a first implementation example of the first embodiment of the present invention.

FIG. 37 is a top view showing a detailed configuration of a radiator 100 of the antenna apparatus of FIG. 36.

FIG. 38 is a graph showing a frequency characteristic of an S parameter S11 indicative of the reflection coefficient of the antenna apparatus of FIG. 36.

FIG. 39 is a schematic diagram showing an antenna apparatus according to a second implementation example of the first embodiment of the present invention.

FIG. 40 is a top view showing a detailed configuration of a radiator 105 of the antenna apparatus of FIG. 39.

FIG. 41 is a graph showing a frequency characteristic of an S parameter S11 indicative of the reflection coefficient of the antenna apparatus of FIG. 39.

FIG. 42 is a schematic diagram showing an antenna apparatus according to a third implementation example of the first embodiment of the present invention.

FIG. 43 is a development view showing a detailed configuration of a radiator 121 of the antenna apparatus of FIG. 42.

FIG. 44 is a schematic diagram showing an antenna apparatus according to a first implementation example of the second embodiment of the present invention.

FIG. 45 is a schematic diagram showing an antenna apparatus according to a second implementation example of the second embodiment of the present invention.

FIG. 46 is a graph showing a frequency characteristic of an S parameter S11 indicative of the reflection coefficient of the antenna apparatus of FIG. 42.

FIG. 47 is a graph showing the frequency characteristics of S parameters S11 and S21 indicative of the reflection coefficient and transmission coefficient of the antenna apparatus of FIG. 44.

FIG. 48 is a graph showing the frequency characteristics of S parameters S11 and S21 indicative of the reflection coefficient and transmission coefficient of the antenna apparatus of FIG. 45.

FIG. 49 is a radiation pattern diagram of a radiator 121 on the −Y side for the case where the antenna apparatus of FIG. 44 operates at the low-band resonance frequency f1.

FIG. 50 is a radiation pattern diagram of a radiator 122 on the +Y side for the case where the antenna apparatus of FIG. 44 operates at the low-band resonance frequency f1.

FIG. 51 is a radiation pattern diagram of the radiator 121 on the −Y side for the case where the antenna apparatus of FIG. 44 operates at the high-band resonance frequency f2.

FIG. 52 is a radiation pattern diagram of the radiator 122 on the +Y side for the case where the antenna apparatus of FIG. 44 operates at the high-band resonance frequency f2.

FIG. 53 is a diagram for illustrating a main radiation direction for the case where the antenna apparatus of FIG. 44 operates at the high-band resonance frequency f2.

FIG. 54 is a block diagram showing a configuration of a wireless communication apparatus according to a third embodiment of the present invention, the wireless communication apparatus being provided with an antenna apparatus of FIG. 1.

### DESCRIPTION OF EMBODIMENTS

Embodiments of the present invention will be described below with reference to the drawings. It is noted that like components are denoted by the same reference signs.

### First Embodiment

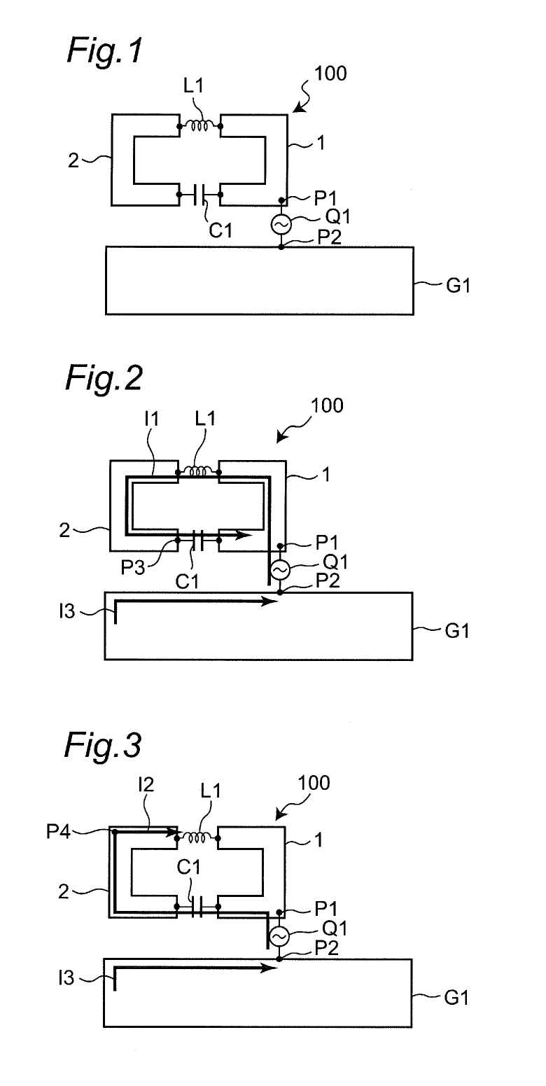

FIG. 1 is a schematic diagram showing an antenna apparatus according to a first embodiment of the present invention. The antenna apparatus of the present embodiment is characterized by using a single radiator 100 for dual-band operation.

Referring to FIG. 1, the radiator 100 has: a first radiation conductor 1 having a certain width and a certain electrical length, a second radiation conductor 2 having a certain width and a certain electrical length, a capacitor C1 connecting the radiation conductors 1 and 2 to each other at a certain position, and an inductor L1 connecting the radiation conductors 1 and 2 to each other at a certain position different from the position of the inductor L1. In the radiator 100, the radiation conductors 1 and 2, the capacitor C1, and the inductor L1 form a loop surrounding a central hollow portion. In other words, the capacitor C1 is inserted at a position along the looped radiation conductor, and the inductor L1 is inserted at a position different from the position where the capacitor C1 is inserted. A signal source Q1 generates a radio-frequency signal having a low-band resonance frequency f1 and a radio-frequency signal having a high-band resonance frequency f2, and the signal source Q1 is connected to a feed point P1 on the radiation conductor 1, and connected to a connecting point P2 on a ground conductor G1 close to the radiator 100. The signal source Q1 schematically shows a wireless communication circuit connected to the antenna apparatus of FIG. 1. The signal source Q1 excites the radiator 100 at one of the low-band resonance frequency f1 and the high-band resonance frequency f2. If necessary, a matching circuit (not shown) may be further connected between the antenna apparatus and the wireless communication circuit. In the radiator 100, a current path for the case where the radiator 100 is excited at the low-band resonance frequency f1 is different from a current path for the case where the radiator 100 is excited at the high-band resonance frequency f2, and thus, the antenna apparatus can effectively achieve dual-band operation.

FIG. 2 is a diagram showing a current path for the case where the antenna apparatus of FIG. 1 operates at the low-band resonance frequency f1. By nature, a current having a low frequency component can pass through an inductor (low impedance), but is hard to pass through a capacitor (high impedance). Hence, a current I1 for the case where the antenna apparatus operates at the low-band resonance frequency f1 flows through a path along the looped radiation conductor, the path including the inductor L1. Specifically, the current I1 flows through a portion of the radiation conductor 1 from the feed point P1, to a point connected to the inductor L1, passes through the inductor L1, and flows through a portion of the radiation conductor 2 from a point connected to the inductor L1, to a point connected to the capacitor C1. Further, due to a voltage difference across both ends of the capacitor C1, a current flows through a portion of the radiation conductor 1 from a point connected to the capacitor C1, to the feed point P1, and the current is connected to the current I1. Hence, it can be considered that the current I1 substantially also passes through the capacitor C1. The current I1 flows strongly along an inner edge of the looped radiation conductor, close to the central hollow portion. In addition, a current I3 flows along a portion of the ground conductor G1, the portion being close to the radiator 100, and flows toward the connecting point P2. The radiator 100 is configured such that when the antenna apparatus operates at the low-band resonance frequency f2, the current I1 flows through a current path as shown in FIG. 2, and the looped radiation conductor, the inductor L1, and the capacitor C1 resonate at the low-band resonance frequency f1. Specifically, the radiator 100 is configured such that the sum of the electrical length of the portion of the radiation conductor 1 from the feed point P1 to the point connected to the inductor L1, the electrical length of the portion of the radiation conductor 1 from the feed point P1 to the point connected to the capacitor C1, the electrical length of the inductor L1, the electrical length of the capacitor C1, and the electrical length of the portion of the radiation conductor 2 from the point connected to the inductor L1 to the point connected to the capacitor C1 is an electrical length at which the radiator 100 resonates at the low-band resonance frequency f1. The electrical length at which the radiator 101 resonates is, for example, 0.2 to 0.25 times of an operating wavelength λ1 of the low-band resonance frequency f1. When the antenna apparatus operates at the low-band resonance frequency f1, the current I1 flows through the current path as shown in FIG. 2, and therefore, the radiator 100 operates in a loop antenna mode, i.e., a magnetic current mode.

It is noted that when the antenna apparatus operates at the low-band resonance frequency f1, most of the current I1 is radiated away, until the current I1 flows from the feed point P1, to a point P3 on the radiation conductor 2, which is connected to the capacitor C 1.

Since the radiator 100 operates in the loop antenna mode, it is possible to achieve a long resonant length while maintaining a compact form, thus achieving good characteristics even when the antenna apparatus operates at the low-band resonance frequency f1. In addition, when the radiator 100 operates in the loop antenna mode, the radiator 100 has a high Q value. The wider the central hollow portion of the looped radiation conductor is (i.e., the larger the diameter of the loop is), the more the radiation efficiency of the antenna apparatus improves.

FIG. 3 is a diagram showing a current path for the case where the antenna apparatus of FIG. 1 operates at the high-band resonance frequency f2. By nature, a current having a high frequency component can pass through a capacitor (low impedance), but is hard to pass through an inductor (high impedance). Hence, a current I2 for the case where the antenna apparatus operates at the high-band resonance frequency f2 flows through a section along the looped radiation conductor, the section including the capacitor C1 but not including the inductor L1, and the section extending between the feed point and the inductor. Specifically, the current I2 flows through a portion of the radiation conductor 1 from the feed point P1, to a point connected to the capacitor C1, passes through the capacitor C1, and flows through a portion of the radiation conductor 2 from a point connected to the capacitor C1, to a certain position (e.g., a point connected to the inductor L1). At this time, the current I2 flows strongly along an outer edge of the looped radiation conductor. A current I3 flows through a portion of the ground conductor G1, the portion being close to the radiator 100, and flows toward the connecting point P2 (i.e., in the opposite direction to that of the current I2). The radiator 100 is configured such that when the antenna apparatus operates at the high-band resonance frequency f2, the current I2 flows through a current path as shown in FIG. 3, and a portion of the looped radiation conductor, through which the current I2 flows, and the capacitor C1 resonate at the high-band resonance frequency f2. Specifically, the radiator 100 is configured such that the sum of the electrical length of the portion of the radiation conductor 1 from the feed point P1 to the point connected to the capacitor C1, the electrical length of the capacitor C1, and the electrical length of the portion of the radiation conductor 2 through which the current I2 flows (e.g., the electrical length of the portion of the radiation conductor 2 from the point connected to the capacitor C1 to the point connected to the inductor L1) is an electrical length at which the radiator 100 resonates at the high-band resonance frequency f2. The electrical length at which the radiator 100 resonates is, for example, 0.25 times of an operating wavelength λ2 of the high-band resonance frequency f2. When the antenna apparatus operates at the high-band resonance frequency f2, the current I2 flows through a current path as shown in FIG. 3, and therefore, the radiator 100 operates in a monopole antenna mode, i.e., a current mode.

It is noted that when the antenna apparatus operates at the high-band resonance frequency f2, most of the current I2 is radiated away, until the current I2 flows from the feed point P1 to a point P4 at a corner of the radiation conductor 2.

As described above, when the antenna apparatus of the present embodiment operates at the low-band resonance frequency f1, the antenna apparatus forms the current path through the inductor L1, and when the antenna apparatus operates at the high-band resonance frequency f2, the antenna apparatus forms the current path through the capacitor C1. Thus, the antenna apparatus effectively achieves dual-band operation. The radiator 100 operates in a magnetic current mode by forming a looped current path, and resonates at the low-band resonance frequency f1. On the other hand, the radiator 100 operates in a current mode by forming a non-looped current path (monopole antenna mode), and resonates at the high-band resonance frequency f2. According to the prior art, when an antenna apparatus operates at the low-band resonance frequency f1 (operating wavelength λ1), an antenna element length of about (λ1)/4 is required. On the other hand, the antenna apparatus of the present embodiment forms the looped current path, and therefore, the lengths in the horizontal and vertical directions of the radiator 100 can be reduced to about (λ1)/15.

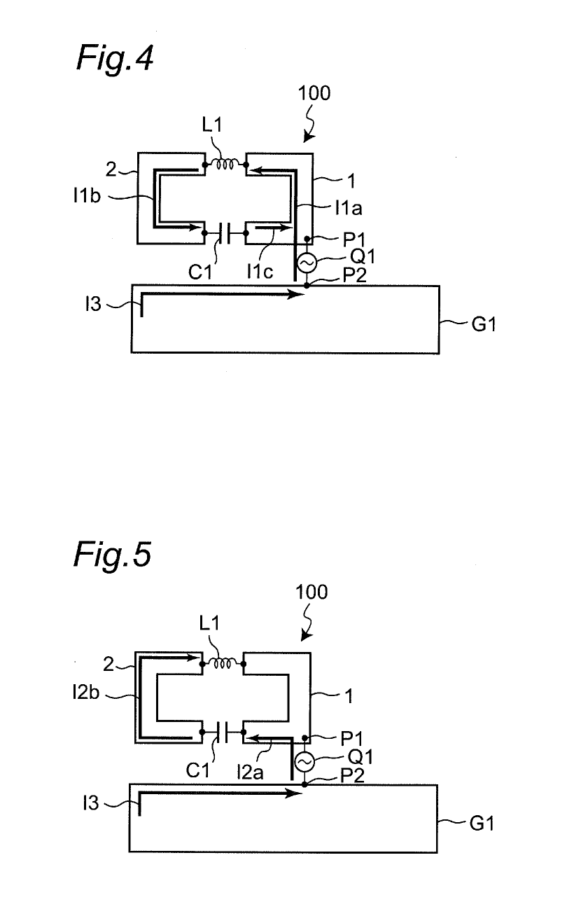

FIG. 4 is a diagram for illustrating a matching effect brought about by the inductor L1 and the capacitor C1 when the antenna apparatus of FIG. 1 operates at the low-band resonance frequency f1. FIG. 5 is a diagram for illustrating a matching effect brought about by the inductor L1 and the capacitor C1 when the antenna apparatus of FIG. 1 operates at the high-band resonance frequency f2. It is possible to adjust the low-band resonance frequency f1 and the high-band resonance frequency f2 using matching effects brought about by the inductor L1 and the capacitor C1 (particularly, a matching effect brought about by the capacitor C1). When the antenna apparatus operates at the low-band resonance frequency f1, a current I1b flowing through a portion of the radiation conductor 2 from the point connected to the inductor L1 to the point connected to the capacitor C1, and a current I1c flowing through a portion of the radiation conductor 1 from the point connected to the capacitor C1 to the feed point P1 are connected to a current I1a flowing through a portion of the radiation conductor 1 from the feed point P1 to the point connected to the inductor L1, and thus, the looped current path is formed. Since a voltage difference appears across both ends of the capacitor C1 (the end on the side of the radiation conductor 1, and the end on the side of the radiation conductor 2), there is an effect of controlling a reactance component of input impedance of the antenna apparatus by capacitance of the capacitor C1. The more the capacitance of the capacitor C1 increases, the lower the resonance frequency of the radiator 100 decreases. On the other hand, when the antenna apparatus operates at the high-band resonance frequency f2, a current flows through a portion of the radiation conductor 1 from the feed point P1 to the point connected to the capacitor C1 (current I2a), passes through the capacitor C1, and flows through a portion of the radiation conductor 2 from the point connected to the capacitor C1 to the point connected to the inductor L1 (current I2b). Since the capacitor C1 passes a high frequency component, reduction in the capacitance of the capacitor C1 results in an reduced electrical length, and therefore, the resonance frequency of the radiator 100 is shifted to a higher frequency. Since the voltage at the feed point P1 is the minimum on the radiator 100, the resonance frequency of the radiator 100 can be decreased by increasing a distance from the feed point P1 to the capacitor C1.

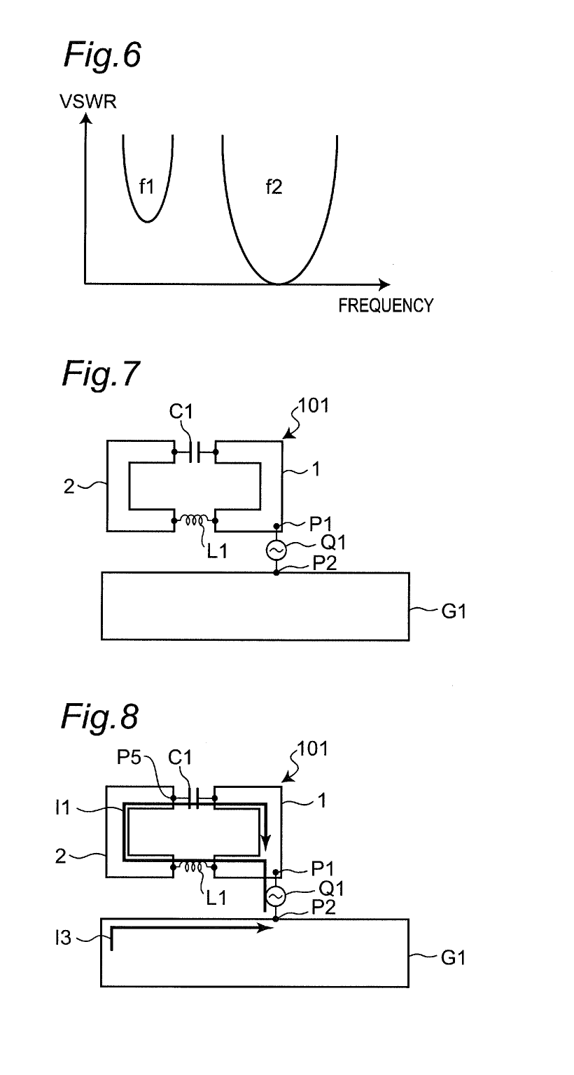

According to the antenna apparatus of FIG. 1, the capacitor C1 is disposed at a closer position to the ground conductor G1, than a position of the inductor L1. Hence, as described above, when the antenna apparatus operates at the low-band resonance frequency f1, the current I1 flows from the feed point P1 to a position on the radiation conductor 2 close to the ground conductor G1 (point P3), and when the antenna apparatus operates at the high-band resonance frequency f2, the current I2 flows from the feed point P1 to a position on the radiation conductor 2 remote from the ground conductor G1 (point P4). That is, the open end of the current I1 is close to the ground conductor G1, and on the other hand, the open end of the current I2 is remote from the ground conductor G1. Therefore, the VSWR for the case where the antenna apparatus operates at the high-band resonance frequency f2 is lower than the VSWR for the case where the antenna apparatus operates at the low-band resonance frequency f1, and therefore, it is possible to more easily achieve matching of the antenna apparatus. FIG. 6 is a schematic diagram showing the frequency characteristics of VSWR according to the antenna apparatus of FIG. 1.

As to an antenna apparatus provided with a looped radiation conductor, and a capacitor and an inductor which are inserted at certain positions along a loop of the radiation conductor, for example, there has been an invention of Patent Literature 3. However, according to the invention of Patent Literature 3, a parallel resonant circuit is formed by a capacitor and an inductor, and the parallel resonant circuit operates in one of a fundamental mode and a higher-order mode depending on a frequency. On the other hand, the invention of the present application is based on a completely novel principle that the radiator 100 operates in one of the loop antenna mode and the monopole antenna mode depending on the operating frequency.

The radiation efficiency of the antenna apparatus improves by increasing the distance between the capacitor C1 and the inductor L1 of the radiator 100 to form a large loop.

As will be described below in implementation examples, the antenna apparatus of the present embodiment can use 800 MHz band frequencies (e.g., 880 MHz) as the low-band resonance frequency f1, and 2000 MHz band frequencies (e.g., 2170 MHz) as the high-band resonance frequency f2. However, the frequencies are not limited thereto.

Each of the radiation conductors 1 and 2 is not limited to be shaped in a strip as shown in FIG. 1, etc., and may have any shape, as long as certain electrical lengths can be obtained between the capacitor C1 and the inductor L1.

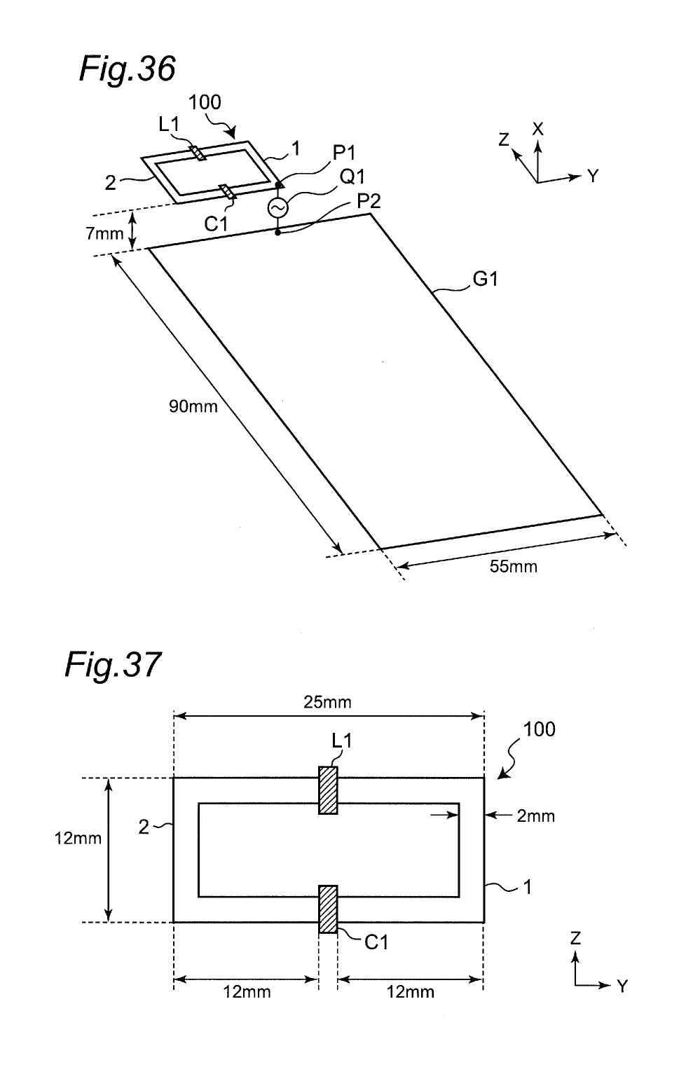

Although FIG. 1, etc., show the ground conductor G1 in small size for ease of illustration, it will be understood by those skilled in the art to use a ground conductor G1 having a sufficient size according to desired performance, as shown in FIG. 36, etc. The antenna apparatus of FIG. 1 and antenna apparatuses of other embodiments and modified embodiments may be formed on a printed circuit board. In this case, the radiator 100 and the ground conductor G1 are formed as conductive patterns on a dielectric substrate. Although the antenna apparatus of FIG. 1 is shown such that the radiator 100 and the ground conductor G1 are disposed on the same plane, the arrangement of the radiator 100 and the ground conductor G1 is not limited thereto. For example, a plane including the radiator 100 may be at a certain angle to a plane including the ground conductor G1. In addition, the radiation conductors 1 and 2 of the radiator 100 may be bent at at least one position.

According to the antenna apparatus of the present embodiment, it is possible to effectively achieve dual-band operation and reduce size of the antenna apparatus, by using the radiator 100 operable in one of the loop antenna mode and the monopole antenna mode depending on the operating frequency.

FIG. 7 is a schematic diagram showing an antenna apparatus according to a first modified embodiment of the first embodiment of the present invention. According to the antenna apparatus of FIG. 1, the capacitor C1 is disposed at the closer position to the ground conductor G1, than the position of the inductor L 1. However, as shown in FIG. 7, the inductor L1 may be disposed at a closer position to the ground conductor C1, than a position of the capacitor C 1. A radiator 101 of the antenna apparatus of FIG. 7 is configured in a manner similar to that of as the radiator 100 of the antenna apparatus of FIG. 1, except for the positions of the capacitor C1 and the inductor L1.

FIG. 8 is a diagram showing a current path for the case where the antenna apparatus of FIG. 7 operates at the low-band resonance frequency f1. A current I1 for the case where the antenna apparatus operates at the low-band resonance frequency f1 flows through a portion of a radiation conductor 1 from a feed point P1, to a point connected to the inductor L1, passes through the inductor L1, and flows through a portion of a radiation conductor 2 from a point connected to the inductor L1, to a point connected to the capacitor C1. Further, due to the voltage difference across both ends of the capacitor C1, a current flows through a portion of the radiation conductor 1 from a point connected to the capacitor C1, to the feed point P1, and the current is connected to the current I1. It is noted that when the antenna apparatus operates at the low-band resonance frequency f1, most of the current I1 is radiated away, until the current I1 flows from the feed point P1, to a point P5 on the radiation conductor 2, which is connected to the capacitor C1.

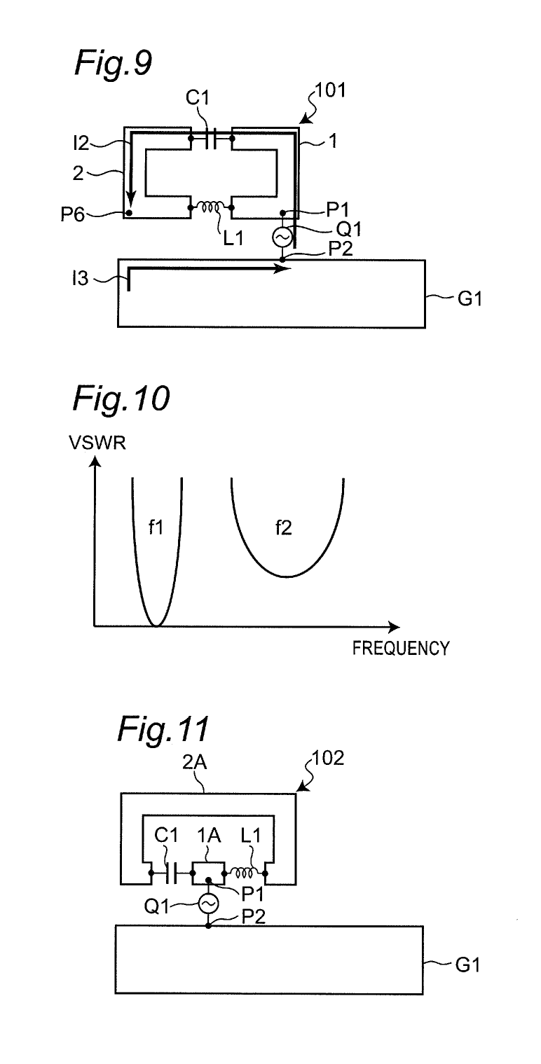

FIG. 9 is a diagram showing a current path for the case where the antenna apparatus of FIG. 7 operates at the high-band resonance frequency f2. A current I2 for the case where the antenna apparatus operates at the high-band resonance frequency f2 flows through a portion of the radiation conductor 1 from the feed point P1, to a point connected to the capacitor C1, passes through the capacitor C1, and flows through a portion of the radiation conductor 2 from a point connected to the capacitor C1, to a certain position. It is noted that when the antenna apparatus operates at the high-band resonance frequency f2, most of the current I2 is radiated away, until the current I2 flows from the feed point P1 to a point P6 at a corner of the radiation conductor 2.

According to the antenna apparatus of FIG. 7, the inductor L1 may be disposed at the closer position to the ground conductor G1, than the position of the capacitor C1. Hence, as described above, when the antenna apparatus operates at the low-band resonance frequency f1, the current I1 flows from the feed point P1 to the position on the radiation conductor 2 remote from the ground conductor G1 (point P5), and when the antenna apparatus operates at the high-band resonance frequency f2, the current I2 flows from the feed point P1 to a position on the radiation conductor 2 close to the ground conductor G1 (point P6). That is, the open end of the current I2 is close to the ground conductor G1, and on the other hand, the open end of the current I1 is remote from the ground conductor G1. Therefore, the VSWR for the case where the antenna apparatus operates at the low-band resonance frequency f1 is lower than the VSWR for the case where the antenna apparatus operates at the high-band resonance frequency f2, and therefore, it is possible to more easily achieve matching of the antenna apparatus. FIG. 10 is a schematic diagram showing the frequency characteristics of VSWR according to the antenna apparatus of FIG. 7.

Also according to the antenna apparatus of FIG. 7, it is possible to effectively achieve dual-band operation and reduce size of the antenna apparatus, by using the radiator 101 operable in one of the loop antenna mode and the monopole antenna mode depending on the operating frequency.

FIG. 11 is a schematic diagram showing an antenna apparatus according to a second modified embodiment of the first embodiment of the present invention. In a radiator 102 of the antenna apparatus of FIG. 11, radiation conductors 1A and 2A, a capacitor C1, and an inductor L1 form a loop surrounding a central hollow portion. The capacitor C1 and the inductor L1 of the radiator 102 are provided along the looped radiation conductor and at a portion where the radiation conductor and a ground conductor G1 are close to each other. A feed point P1 is provided between the capacitor C1 and the inductor L1.

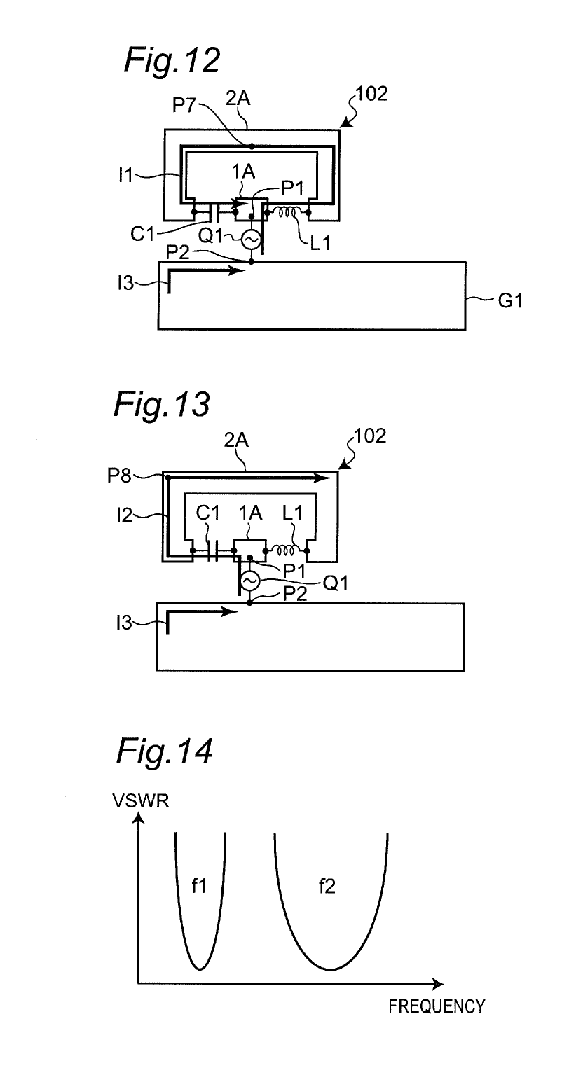

FIG. 12 is a diagram showing a current path for the case where the antenna apparatus of FIG. 11 operates at the low-band resonance frequency f1. A current I1 for the case where the antenna apparatus operates at the low-band resonance frequency f1 flows through a portion of the radiation conductor 1A from the feed point P1, to a point connected to the inductor L1, passes through the inductor L1, and flows through a portion of the radiation conductor 2A from a point connected to the inductor L1, to a point connected to the capacitor C1. Further, due to the voltage difference across both ends of the capacitor C1, a current flows through a portion of the radiation conductor 1A from a point connected to the capacitor C1, to the feed point P1, and the current is connected to the current I1. It is noted that when the antenna apparatus operates at the low-band resonance frequency f1, most of the current I1 is radiated away, until the current I1 flows from the feed point P1 to a point P7 on the radiation conductor 2 remote from the ground conductor G1.

FIG. 13 is a diagram showing a current path for the case where the antenna apparatus of FIG. 11 operates at the high-band resonance frequency f2. A current I2 for the case where the antenna apparatus operates at the high-band resonance frequency f2 flows through a portion of the radiation conductor 1A from the feed point P1, to a point connected to the capacitor C1, passes through the capacitor C1, and flows through a portion of the radiation conductor 2A from a point connected to the capacitor C1, to a certain position. It is noted that when the antenna apparatus operates at the high-band resonance frequency f2, most of the current I2 is radiated away, until the current I2 flows from the feed point P1 to a point P8 at a corner of the radiation conductor 2A.

According to the antenna apparatus of FIG. 11, both the capacitor C1 and the inductor L1 are close to the ground conductor C1, and therefore, the radiation conductor 1A provided with the feed point P1 is shorter than the radiation conductor 1 of FIG. 1. Since the radiation conductor 1A is short, it is possible to more easily separate a current path for the case where the antenna apparatus operates at the low-band resonance frequency f1, from a current path for the case where the antenna apparatus operates at the high-band resonance frequency f2.

In addition, according to the antenna apparatus of FIG. 11, both the capacitor C1 and the inductor L1 are close to the ground conductor G1. Hence, as described above, when the antenna apparatus operates at the low-band resonance frequency f1, the current I1 flows from the feed point P1 to the position on the radiation conductor 2A remote from the ground conductor G1 (point P7), and when the antenna apparatus operates at the high-band resonance frequency f2, too, the current I2 flows from the feed point P1 to the position on the radiation conductor 2A remote from the ground conductor G1 (point P8). That is, both the open ends of the current I1 and the current I2 are remote from the ground conductor G1. Therefore, low VSWR is obtained for both the cases where the antenna apparatus operates at the low-band resonance frequency f1 and the case where the antenna apparatus operates at the high-band resonance frequency f2, and therefore, it is possible to more easily achieve matching of the antenna apparatus. FIG. 14 is a schematic diagram showing the frequency characteristics of VSWR according to the antenna apparatus of FIG. 11.

Also according to the antenna apparatus of FIG. 11, it is possible to effectively achieve dual-band operation and reduce size of the antenna apparatus, by using the radiator 102 operable in one of the loop antenna mode and the monopole antenna mode depending on the operating frequency.

By selecting any of the configurations of FIGS. 1, 7, and 11 according to system requirements, it is possible to design an optimal multiband antenna for a desired wireless communication apparatus.

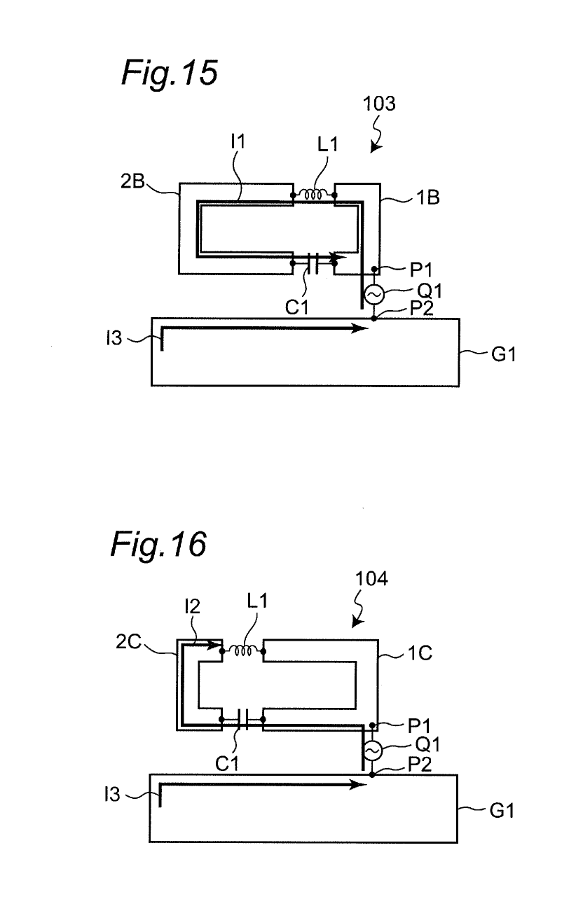

FIG. 15 is a schematic diagram showing an antenna apparatus according to a third modified embodiment of the first embodiment of the present invention. FIG. 16 is a schematic diagram showing an antenna apparatus according to a fourth modified embodiment of the first embodiment of the present invention. How to adjust the resonance frequency of the antenna apparatus can be summarized as follows. In order to decrease the low-band resonance frequency f1, it is effective, for example, to increase the capacitance of the capacitor C1, to increase the inductance of the inductor L1, to increase the electrical length of the radiation conductor 1, and to increase the electrical length of the radiation conductor 2, etc. In order to decrease the high-band resonance frequency f2, it is effective, for example, to increase the electrical length of the radiation conductor 2, and to increase a distance from the feed point P1 to the capacitor C1, etc. FIG. 15 shows an antenna apparatus configured to decrease the low-band resonance frequency f1. In a radiator 103 of the antenna apparatus of FIG. 15, radiation conductors 1B and 2B, a capacitor C1, and an inductor L1 form a loop surrounding a central hollow portion. According to the radiator 103 of the antenna apparatus of FIG. 15, the low-band resonance frequency f1 is decreased by increasing the electrical length of the radiation conductor 2. FIG. 16 shows an antenna apparatus configured to decrease the high-band resonance frequency f2. In a radiator 104 of the antenna apparatus of FIG. 16, radiation conductors 1C and 2C, a capacitor C1, and an inductor L1 form a loop surrounding a central hollow portion. According to the radiator 104 of the antenna apparatus of FIG. 16, the high-band resonance frequency f2 is decreased by increasing a distance from a feed point P1 to the capacitor C1.

In order to surely change the operation of the antenna apparatus between a magnetic current mode and a current mode, it is necessary to for the current paths for the case where the antenna apparatus operates at the low-band resonance frequency f1 and the case where the antenna apparatus operates at the high-band resonance frequency f2 to have distinctly different electrical lengths from each other. To this end, it is preferred that the electrical length of the radiation conductor 2 be longer than that of the radiation conductor 1. In addition, by reducing the electrical length of a portion of the radiation conductor 1 from the feed point P1 to the inductor L1 and the electrical length of a portion of the radiation conductor 1 from the feed point P1 to the capacitor C1, it is possible to suppress occurrence of a current flowing in an unwanted direction, such that a current tends to flow from the feed point P1 to the inductor L1 when the antenna apparatus operates at the low-band resonance frequency f1, and a current tends to flow from the feed point P1 to the capacitor C1 when the antenna apparatus operates at the high-band resonance frequency f2.

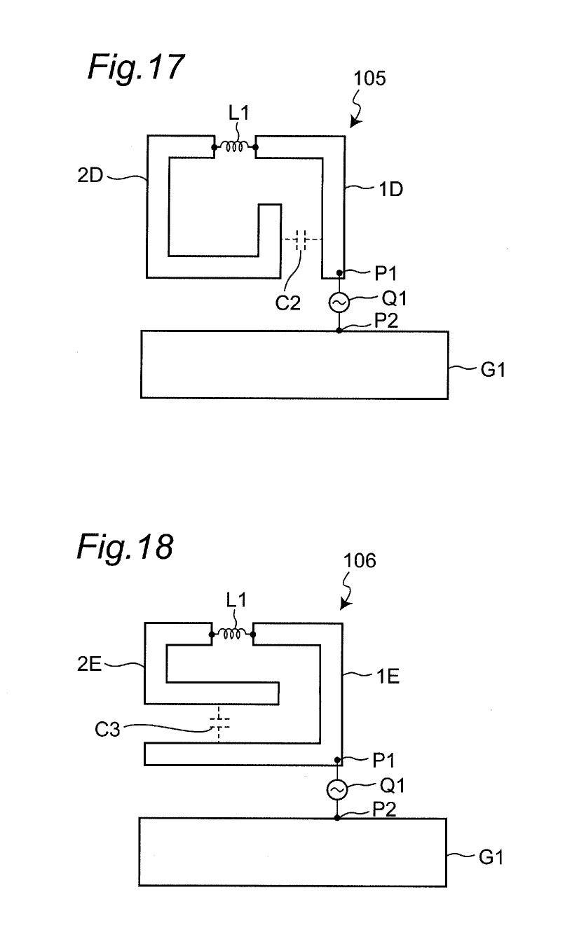

As to the capacitor C1 and the inductor L 1, for example, it is possible to use discrete circuit elements, but the capacitor C1 and the inductor L1 are not limited thereto. With reference to FIGS. 17 to 22, modified embodiments of the capacitor C1 and the inductor L1 will be described below.

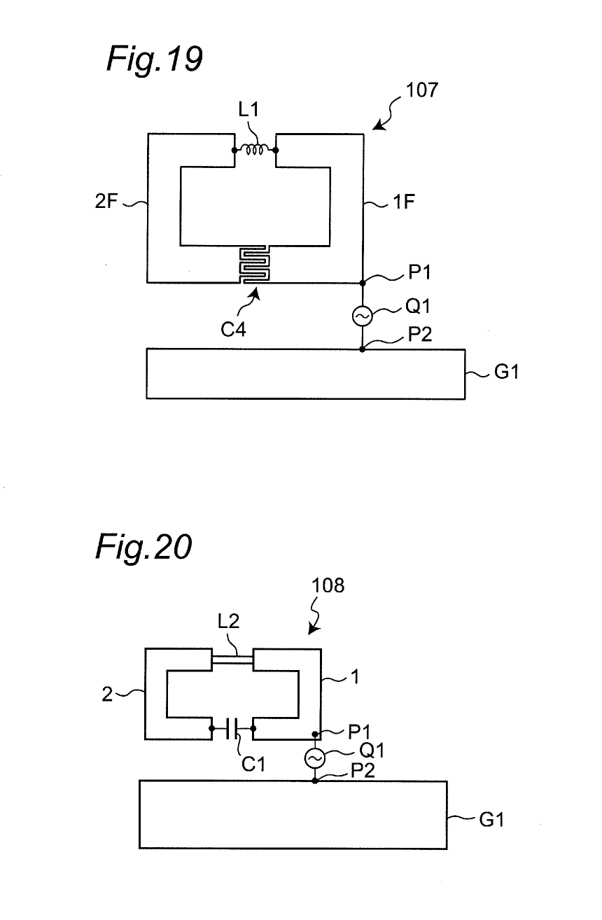

FIG. 17 is a schematic diagram showing an antenna apparatus according to a fifth modified embodiment of the first embodiment of the present invention. FIG. 18 is a schematic diagram showing an antenna apparatus according to a sixth modified embodiment of the first embodiment of the present invention. In a radiator 105 of the antenna apparatus of FIG. 17, radiation conductors 1D and 2D and an inductor L1 form a loop surrounding a central hollow portion. A capacitor C2 is formed at a portion where the radiation conductors 1D and 2D are close to each other. In addition, in a radiator 106 of the antenna apparatus of FIG. 18, radiation conductors 1E and 2E and an inductor L1 form a loop surrounding a central hollow portion. A capacitor C3 is formed at a portion where the radiation conductors 1E and 2E are close to each other. As shown in FIGS. 17 and 18, a virtual capacitor C2 or C3 may be formed between the two radiation conductors, by arranging the radiation conductors close to each other to produce a certain capacitance between the radiation conductors. The closer the two radiation conductors approach to each other, and the wider the area where the two radiation conductors are close to each other increases, the more the capacitance of the virtual capacitor C2 or C3 increases. Further, FIG. 19 is a schematic diagram showing an antenna apparatus according to a seventh modified embodiment of the first embodiment of the present invention. In a radiator 107 of the antenna apparatus of FIG. 19, radiation conductors 1F and 2F and an inductor L1 form a loop surrounding a central hollow portion. A capacitor C4 is formed at a portion where the radiation conductors 1F and 2F are close to each other. As shown in FIG. 19, when forming the virtual capacitor C4 by a capacitance between the radiation conductors 1F and 2F, interdigital conductive portions (a configuration in which fingered conductors are engaged alternately) may be formed. The capacitor C4 of FIG. 19 can increase the capacitance as compared to the capacitors C2 and C3 of FIGS. 17 and 18. A capacitor formed by portions of the radiation conductors 1 and 2 close to each other is not limited to linear conductive portions as shown in FIGS. 17 and 18, or interdigital conductive portions as shown in FIG. 19, and may be formed by conductive portions of other shapes.

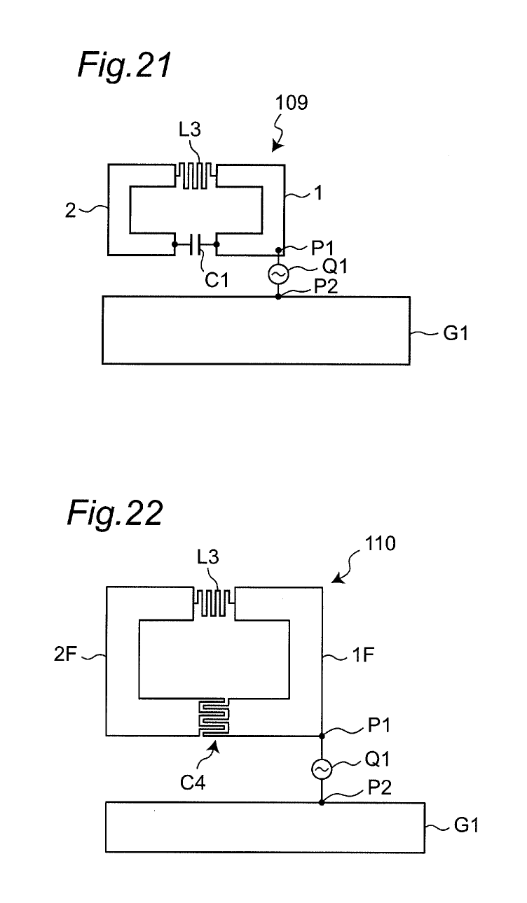

FIG. 20 is a schematic diagram showing an antenna apparatus according to an eighth modified embodiment of the first embodiment of the present invention. A radiator 108 of the antenna apparatus of FIG. 20 is provided with an inductor L2 made of a strip conductor, instead of the inductor L1 of FIG. 1. FIG. 21 is a schematic diagram showing an antenna apparatus according to a ninth modified embodiment of the first embodiment of the present invention. A radiator 109 of the antenna apparatus of FIG. 21 includes an inductor L3 made of a meander conductor, instead of the inductor L1 of FIG. 1. The thinner the widths of conductors forming the inductors L2 and L3 are, and the longer the lengths of the conductors are, the more the inductances of the inductors L2 and L3 increase.

The capacitors C2, C3, and C4 and the inductors L2 and L3 shown in FIGS. 17 to 21 may be combined. For example, a radiator may be provided with the capacitor C2 of FIG. 17 and the inductor L2 of FIG. 20, instead of the capacitor C1 and the inductor L1 of FIG. 1. FIG. 22 is a schematic diagram showing an antenna apparatus according to a tenth modified embodiment of the first embodiment of the present invention. In a radiator 110 of the antenna apparatus of FIG. 22, radiation conductors 1F and 2F and an inductor L3 (see FIGS. 19 and 21) form a loop surrounding a central hollow portion. A capacitor C4 is formed at a portion where the radiation conductors 1F and 2F are close to each other (see FIG. 19). According to the antenna apparatus of FIG. 22, since both the capacitor and the inductor can be formed as conductive patterns on a dielectric substrate, there are advantageous effects such as cost reduction and reduction in variations of manufacture.

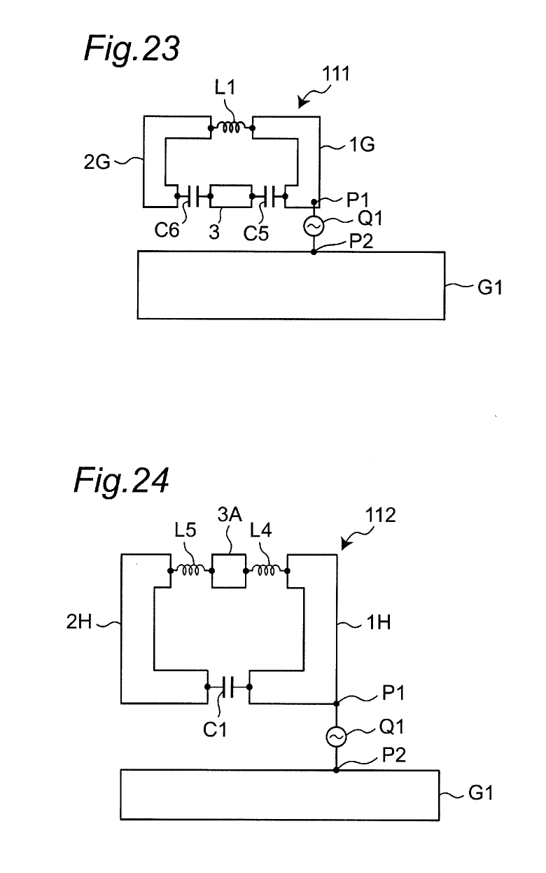

FIG. 23 is a schematic diagram showing an antenna apparatus according to an eleventh modified embodiment of the first embodiment of the present invention. FIG. 23 shows an antenna apparatus provided with a plurality of capacitors C5 and C6. In a radiator 111 of the antenna apparatus of FIG. 23, radiation conductors 1G, 2G, and 3, the capacitors C5 and C6, and an inductor L1 form a loop surrounding a central hollow portion. An antenna apparatus of the present embodiment is not limited to the one provided with a single capacitor and a single inductor, and may be provided with cascaded capacitors including a plurality of capacitors, and/or cascaded inductors including a plurality of inductors. Referring to FIG. 23, the capacitors C5 and C6 connected to each other by a third radiation conductor 3 having a certain electrical length are inserted, instead of the capacitor C1 of FIG. 1. In other words, the capacitors C5 and C6 are inserted at different positions along a looped radiation conductor.

Now, an effect brought about by the plurality of capacitors C5 and C6 is described.

When the capacitance of the capacitor C1 of the antenna apparatus of FIG. 1 is reduced, the band for the case where the antenna apparatus operates at the low-band resonance frequency f1 is broaden. However, since the high-band resonance frequency f2 of the antenna apparatus is shifted to a higher frequency, the efficiency of the antenna apparatus when operating at a desired high-band resonance frequency (e.g., 2000 MHz) decreases. From another point of view, when the capacitance of the capacitor C1 is reduced, the impedance Z1=1/(j×ω×C1) of the capacitor C1 seen from the feed point P1 is large. Thus, the current I2 for the case where the antenna apparatus operates at the high-band resonance frequency f2 is hard to flow, thus reducing the efficiency for the high-band resonance frequency f2. Herein, “C1” also denotes the capacitance of the capacitor C1, and “ω” denotes the angular frequency of a current flowing through the capacitor C1. On the other hand, when the capacitance of the capacitor C1 is increased, the high-band resonance frequency f2 of the antenna apparatus is shifted to a lower frequency, and thus, the efficiency of the antenna apparatus when operating at a desired high-band resonance frequency (e.g., 2000 MHz) improves. However, the band for the case where the antenna apparatus operates at the low-band resonance frequency f1 is narrowed and shifted to a lower frequency band. Therefore, the efficiency of the antenna apparatus when operating at a desired low-band resonance frequency (e.g., 800 MHz) decreases. Thus, there is a trade-off between the efficiency of the antenna apparatus when operating at the low-band resonance frequency f1 and the efficiency of the antenna apparatus when operating at the high-band resonance frequency f2, depending on the capacitance of the capacitor C1.

When the plurality of capacitors C5 and C6 are provided as shown in FIG. 23, the capacitance of the capacitor C5 close to a feed point P1 is set to be larger than that of the capacitor C5 remote from the feed point P1 (C5>C6). In particular, the capacitance of the capacitor C5 is set such that the capacitor C5 has a small impedance Z5=1/(j×ω×C5) when the antenna apparatus operates at the high-band resonance frequency f2. Thus, the current I2 for the case where the antenna apparatus operates at the high-band resonance frequency f2 flows from the feed point P1 and passes through the capacitor C5, and flows well at least to the capacitor C6. In this case, due to the radiation resistance of the radiation conductor 3, the efficiency of the antenna apparatus when operating at the high-band resonance frequency f2 improves. On the other hand, the capacitance of the capacitor C6 is set such that the combined impedance Z of the capacitors C5 and C6, Z≅1/(j×ω×C5)+1/(j×ω×C6)=1/(j×ω×C), reaches a desired magnitude when the antenna apparatus operates at the low-band resonance frequency f1. “C” denotes the combined capacitance C=C5×C6/(C5+C6) of the series-connected capacitors C5 and C6. Thus, it is possible to improve the efficiency of the antenna apparatus, regardless of whether the antenna apparatus operates at the low-band resonance frequency f1 or the high-band resonance frequency f2.

Also in the case of including a plurality of inductors, an antenna apparatus is configured in a manner similar to that of the modified embodiment of FIG. 23. FIG. 24 is a schematic diagram showing an antenna apparatus according to a twelfth modified embodiment of the first embodiment of the present invention. FIG. 24 shows an antenna apparatus provided with a plurality of inductors L4 and L5. In a radiator 112 of the antenna apparatus, of FIG. 24, radiation conductors 1H, 2H, and 3A, a capacitor C1, and the inductors L4 and L5 form a loop surrounding a central hollow portion. Referring to FIG. 24, inductors L4 and L5 connected to each other by the third radiation conductor 3 having a certain electrical length are inserted, instead of the inductor L1 of FIG. 1. In other words, the inductors L4 and L5 are inserted at different positions along the looped radiation conductor.

In a manner similar to that of the antenna apparatuses of FIGS. 23 and 24, a plurality of capacitors and a plurality of inductors may be inserted at different positions along the looped radiation conductor. According to the antenna apparatuses of FIGS. 23 and 24, capacitors and inductors can be inserted at three or more different positions, taking into consideration the current distribution on the radiator. Thus, there is an advantageous effect that it is possible to easily make fine adjustments to the low-band resonance frequency f1 and the high-band resonance frequency f2 when designing an antenna apparatus.

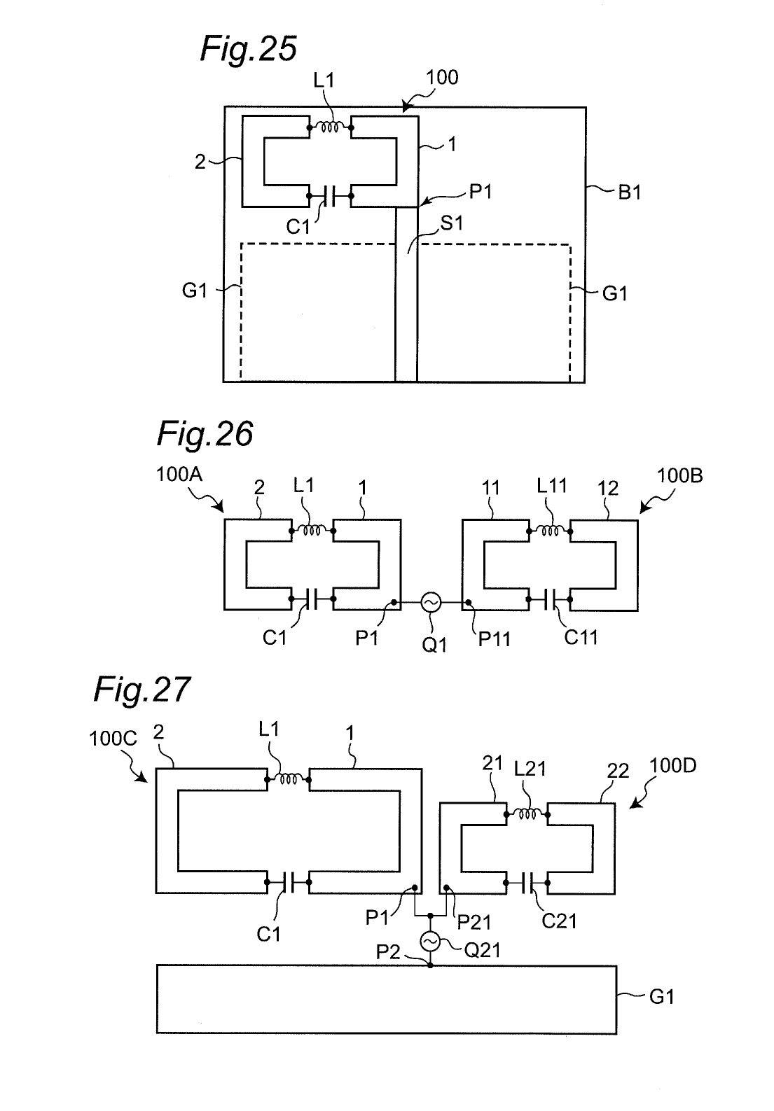

FIG. 25 is a schematic diagram showing an antenna apparatus according to a thirteenth modified embodiment of the first embodiment of the present invention. FIG. 25 shows an antenna apparatus provided with a feed line as a microstrip line. The antenna apparatus of the present modified embodiment is provided with a feed line as a microstrip line, including a ground conductor G1, and a strip conductor S1 provided on the ground conductor G1 with a dielectric substrate B1 therebetween. The antenna apparatus of the present modified embodiment may have a planar configuration for reducing the profile of the antenna apparatus, in other words, the ground conductor G1 may be formed on the back side of a printed circuit board (not shown), and the strip conductor S1 and a radiator 100 may be integrally formed on the front side of the printed circuit board. The feed line is not limited to a microstrip line, and may be a coplanar line, a coaxial line, etc.

FIG. 26 is a schematic diagram showing an antenna apparatus according to a fourteenth modified embodiment of the first embodiment of the present invention. FIG. 26 shows an antenna apparatus configured as a dipole antenna. A left radiator 100A of FIG. 26 is configured in a manner similar to that of the radiator 100 of FIG. 1. A right radiator 100B of FIG. 26 is also configured in a manner similar to that of the radiator 100 of FIG. 1, and has a first radiation conductor 11, a second radiation conductor 12, a capacitor C 11, and an inductor L11. A signal source Q1 is connected to a feed point P1 of the radiator 100A and to a feed point P11 of the radiator 100B. The antenna apparatus of the present modified embodiment has a dipole configuration, and therefore, is operable in a balance mode, thus suppressing unwanted radiation.

FIG. 27 is a schematic diagram showing an antenna apparatus according to a fifteenth modified embodiment of the first embodiment of the present invention. FIG. 27 shows a multiband antenna apparatus operable in four bands. A left radiator 100C of FIG. 27 is configured in a manner similar to that of the radiator 100 of FIG. 1. A left radiator 100D of FIG. 27 is also configured in a manner similar to that of the radiator 100 of FIG. 1, and has a first radiation conductor 21, a second radiation conductor 22, a capacitor C21, and an inductor L21. However, the electrical length of a loop formed by the radiation conductors 21 and 22, the capacitor C21, and the inductor L21 of the radiator 100D is different from that of a loop formed by radiation conductors 1 and 2, a capacitor C1, and an inductor L1 of the radiator 100C. A signal source Q21 is connected to a feed point P1 on the radiation conductor 1 and to a feed point P21 on the radiation conductor 21, and connected to a connecting point P2 on a ground conductor G1. The signal source Q21 generates a radio frequency signal of the low-band resonance frequency f1 and a radio frequency signal of the high-band resonance frequency f2, and generates another low-band resonance frequency f21 different from the low-band resonance frequency f1 and another high-band resonance frequency f22 different from the high-band resonance frequency f2. The radiator 100C operates in a loop antenna mode at the low-band resonance frequency f1, and operates in a monopole antenna mode at the high-band resonance frequency f2. In addition, the radiator 100D operates in a loop antenna mode at the low-band resonance frequency f21, and operates in a monopole antenna mode at the high-band resonance frequency f22. Thus, the antenna apparatus of the present modified embodiment is capable of multiband operation in four bands. The antenna apparatus of the present modified embodiment can achieve further multiband operation by further providing a radiator.

Further, as another modified embodiment, an antenna apparatus according to the present embodiment can be configured as an inverted-F antenna apparatus, for example, by providing a radiator including planar or linear radiation conductors in parallel with a ground conductor, and short-circuiting a part of the radiator to the ground conductor. Short-circuiting a part of the radiator to the ground conductor results in an increased radiation resistance, and it does not impair the basic operating principle of the antenna apparatus according to the present embodiment.

### Second Embodiment

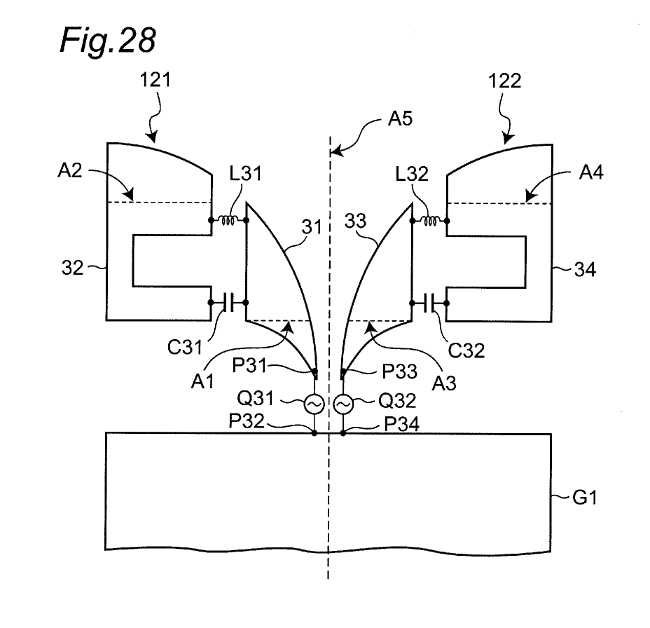

FIG. 28 is a schematic diagram showing an antenna apparatus according to a second embodiment of the present invention. The antenna apparatus of the present embodiment is characterized in that the antenna apparatus includes two radiators 121 and 122 configured according to a similar principle as that of a radiator 100 of FIG. 1, and the radiators 121 and 122 are independently excited by different signal sources Q31 and Q32.

Referring to FIG. 28, the radiator 121 has: a first radiation conductor 31 having a certain electrical length; a second radiation conductor 32 having a certain electrical length; a capacitor C31 connecting the radiation conductors 31 and 32 to each other at a certain position; and an inductor L31 connecting the radiation conductors 31 and 32 to each other at a position different from the position of the capacitor C31. In the radiator 121, the radiation conductors 31 and 32, the capacitor C31, and the inductor L31 form a loop surrounding a central hollow portion. In other words, the capacitor C31 is inserted at a position along the looped radiation conductor, and the inductor L31 is inserted at a position different from the position where the capacitor C31 is inserted. The signal source Q1 is connected to a feed point P31 on the radiation conductor 31, and connected to a connecting point P32 on a ground conductor G1 close to the radiator 121. The radiator 122 is configured in a manner similar to that of the radiator 121, and has a first radiation conductor 33, a second radiation conductor 34, a capacitor C32, and an inductor L32. In the radiator 122, the radiation conductors 33 and 34, the capacitor C32, and the inductor L32 form a loop surrounding a central hollow portion. The signal source Q2 is connected to a feed point P33 on the radiation conductor 33, and connected to a connecting point P34 on the ground conductor G1 close to the radiator 122. The signal sources Q31 and Q32 generate, for example, radio frequency signals as transmitting signals of a MIMO communication scheme, and generate radio frequency signals with the same low-band resonance frequency f1, and generate radio frequency signals with the same high-band resonance frequency f2.

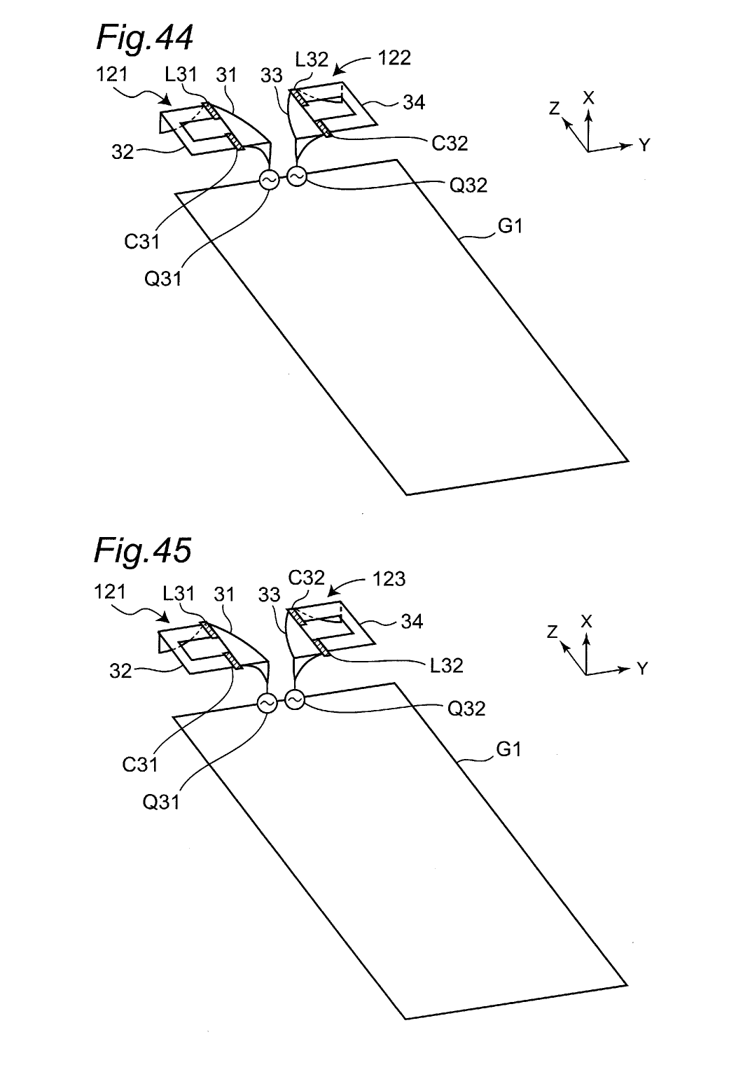

Preferably, the respective radiators 121 and 122 have radiation conductors configured symmetrically with respect to a reference axis A5. The radiation conductors 31 and 33 and feed portions (the feed points P31 and P33, and the connecting points P32 and P33) are provided close to the reference axis A5. The radiation conductors 32 and 34 are provided remote from the reference axis A5. The feed points P31 and P32 are provided at positions symmetric with respect to the reference axis A5. It is possible to reduce the electromagnetic coupling between the radiators 121 and 122, by shaping the radiation conductors of the radiators 121 and 122 such that a distance between the radiators 121 and 122 gradually increases as a distance from feed points P31 and P32 increases. Further, since the distance between the two feed points P31 and P33 is small, it is possible to minimize an area for placing traces of feed lines from a wireless communication circuit (not shown). In addition, in order to reduce the size of the antenna apparatus, any of the radiation conductors 31 to 34 may be bent at at least one position. For example, the radiation conductors 31 and 32 may be bent at the positions of dotted lines A1 to A4 on the radiation conductors 31 and 32 as shown in FIG. 44.

According to the antenna apparatus of FIG. 28, the capacitor C31 is disposed at the closer position to the ground conductor G1, than the position of the inductor L31, and the capacitor C32 is disposed at the closer position to the ground conductor G1, than the position of the inductor L32. However, the positions of the capacitors C31 and C32 and the inductors L31 and L32 are not limited to those shown in FIG. 28. For example, as shown in FIG. 7, the inductor may be disposed at the closer position to the ground conductor G1, than the position of the capacitor, or alternatively, as shown in FIG. 11, a capacitor and an inductor may be provided along a looped radiation conductor and at a portion where the radiation conductor and a ground conductor G1 are close to each other.

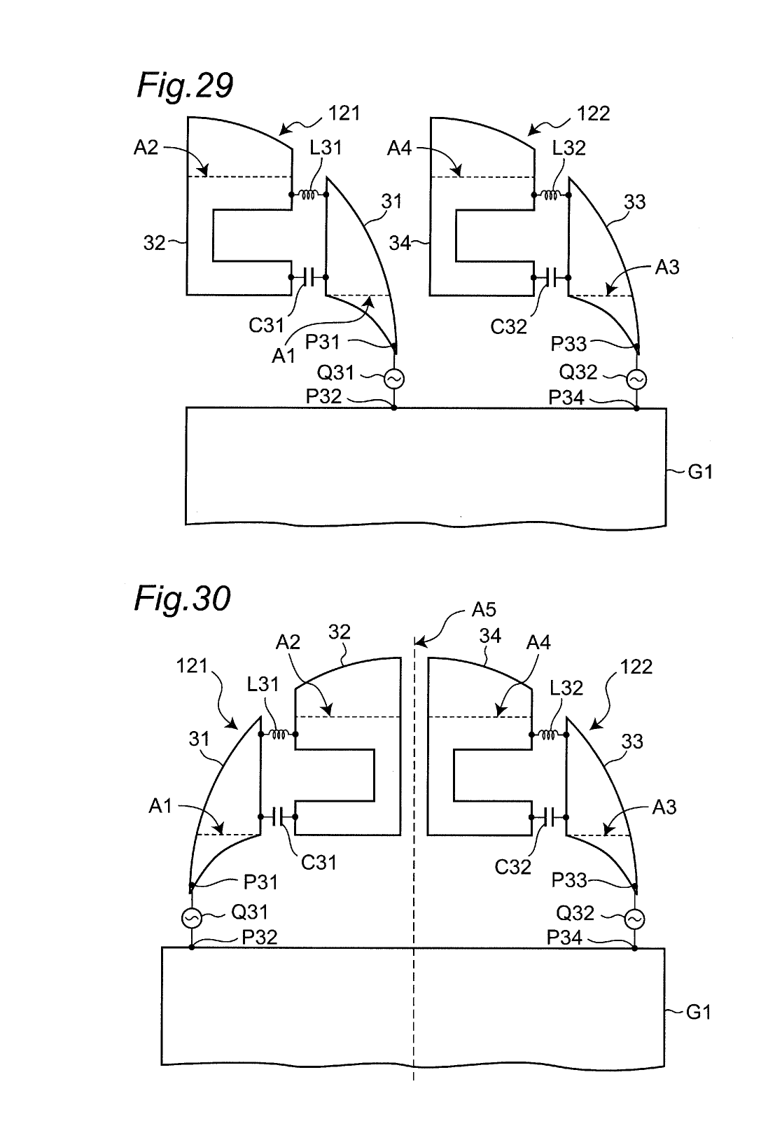

FIG. 29 is a schematic diagram showing an antenna apparatus according to a first modified embodiment of the second embodiment of the present invention. According to the antenna apparatus of the present modified embodiment, radiators 121 and 122 are not disposed symmetrically, but disposed in the same direction (i.e., asymmetrically). Asymmetric disposition of the radiators 121 and 122 results in their asymmetric radiation patterns, thus providing the advantageous effect of a reduced correlation between signals transmitted or received through the radiators 121 and 122. However, since a difference occurs between powers of transmitting signals and between powers of received signals, it is not possible to maximize the receiving performance for a MIMO communication scheme. Further, three or more radiators may be disposed in a manner similar to that of the antenna apparatus of the present modified embodiment.

FIG. 30 is a schematic diagram showing an antenna apparatus according to a comparison example. According to the antenna apparatus of FIG. 30, radiation conductors 32 and 34 without feed points are disposed close to each other. By separating feed points P3 and P33 from each other, it is possible to reduce the correlation between signals transmitted or received through radiators 121 and 122. However, since the open ends of the radiators 121 and 122 (i.e., the edges of the radiation conductors 32 and 34) are opposed to each other, electromagnetic coupling between the radiators 121 and 122 is large.

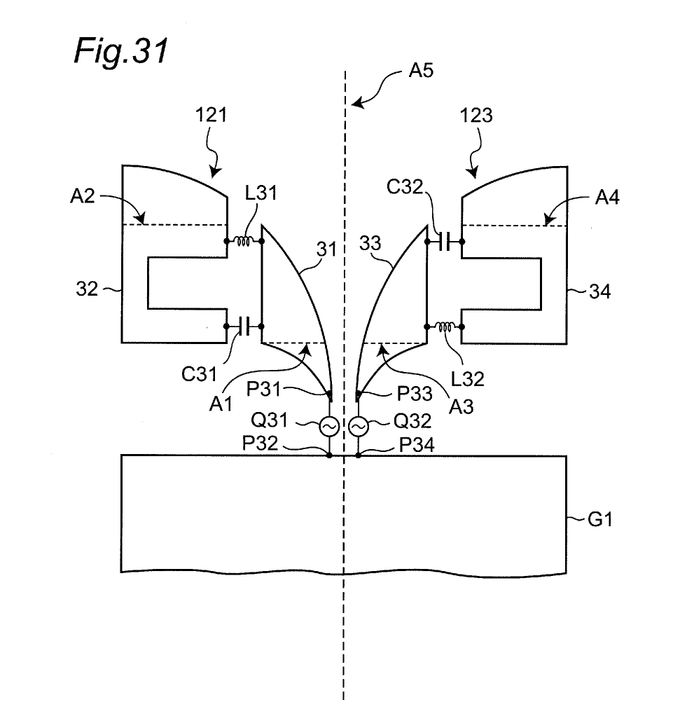

FIG. 31 is a schematic diagram showing an antenna apparatus according to a second modified embodiment of the second embodiment of the present invention. The antenna apparatus of the present modified embodiment includes radiators 121 and 123. The radiator 123 is configured in a manner similar to that of the radiator 121, except that the positions of a capacitor C32 and an inductor L32 of the radiator 123 are opposite to those in the radiator 121. The antenna apparatus of the present modified embodiment is characterized in that in order to reduce electromagnetic coupling between the radiators 121 and 123 for the case where the antenna apparatus operates at the low-band resonance frequency f1, the positions of the capacitor C32 and the inductor L32 of the radiator 123 are configured asymmetrically with respect to the positions of a capacitor C31 and an inductor L31 of the radiator 121.

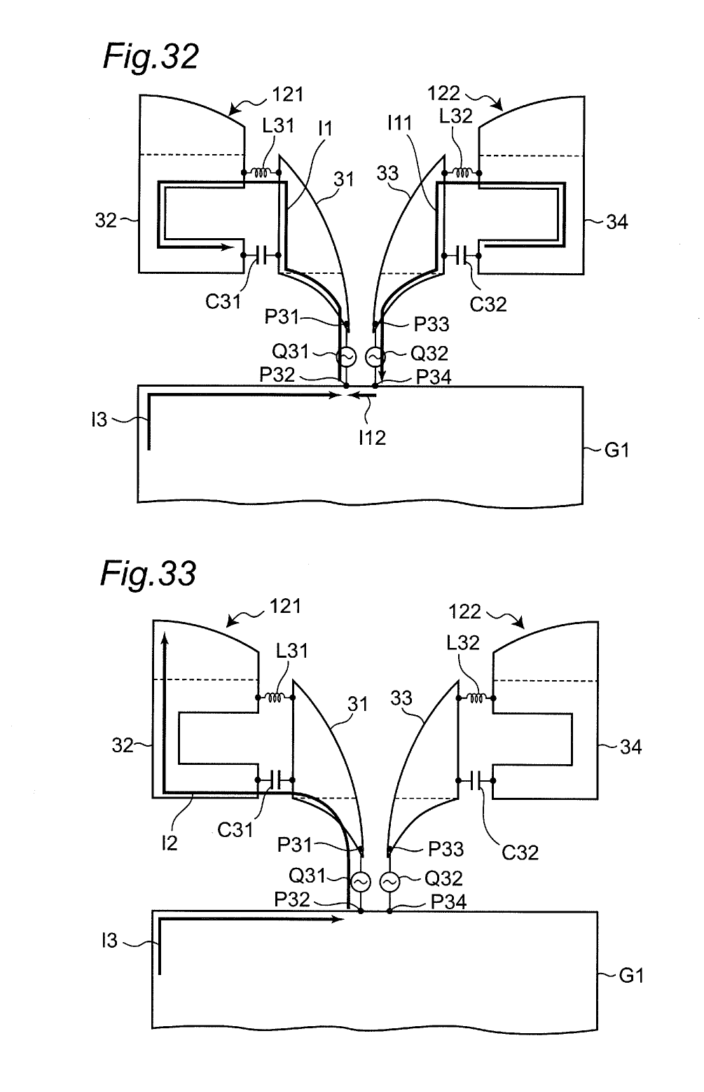

FIG. 32 is a diagram showing a current path for the case where the antenna apparatus of FIG. 28 operates at the low-band resonance frequency f1. We suppose that, for example, only one signal source Q31 operates when the antenna apparatus of the second embodiment operates at the low-band resonance frequency f1. When the radiator 121 operates in a loop antenna mode by a current I1 inputted from the signal source Q31, a magnetic field produced by the radiator 121 induces a current I11 in the radiator 122, the current I11 flowing in the same direction as the current I1, and flowing to the signal source Q32. A current I12 also flows from the connecting point P34 to the connecting point P32 on the ground conductor G1. Since the large current I11 flows, large electromagnetic coupling between the radiators 121 and 122 occurs. FIG. 33 is a diagram showing a current path for the case where the antenna apparatus of FIG. 28 operates at the high-band resonance frequency f2. In the radiator 121, a current I1 inputted from the signal source Q31 flows in a direction remote from the radiator 122. Therefore, electromagnetic coupling between the radiators 121 and 122 is small, and an induced current flowing through the radiator 122 and the signal source Q32 is also small.

Referring to FIG. 31 again, in the antenna apparatus of the present modified embodiment, loops of the radiation conductors of the radiators 121 and 123 are configured substantially symmetrically with respect to the reference axis A5. When proceeding along the symmetric loops of the radiation conductors of the radiators 121 and 123 in corresponding directions starting from the respective feed points (i.e., when proceeding counterclockwise in the radiator 121 and proceeding clockwise in the radiator 123), the radiator 121 is configured such that a feed point P31, the inductor L31, and the capacitor C31 are located in this order, and the radiator 123 is configured such that a feed point P32, the capacitor C32, and the inductor L32 are located in this order. As a result, according to the antenna apparatus of the present modified embodiment, the radiator 121 is configured such that the capacitor C31 is disposed at the closer position to the ground conductor G1, than the position of the inductor L31, and on the other hand, the radiator 122 is configured such that the inductor L32 is disposed at the closer position to the ground conductor G1, than the position of the capacitor C32. Thus, since the capacitors and the inductors are disposed asymmetrically between the radiators 121 and 123, the electromagnetic coupling between the radiators 121 and 123 is reduced.

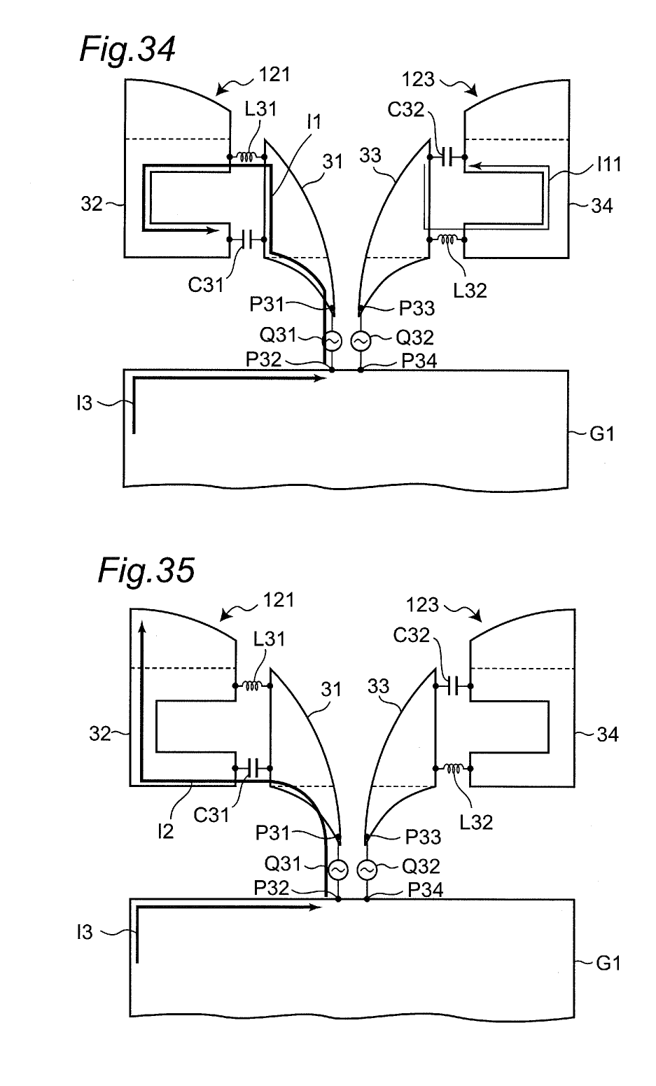

FIG. 34 is a diagram showing a current path for the case where the antenna apparatus of FIG. 31 operates at the low-band resonance frequency f1. As described above, by nature, a current having a low frequency component can pass through an inductor, but is hard to pass through a capacitor. Therefore, even when the radiator 121 operates in a loop antenna mode by a current I1 inputted from a signal source Q31, only a small current I11 is induced in the radiator 122, and also, only a small current flows from the radiator 122 to a signal source Q32. Thus, electromagnetic coupling between the radiators 121 and 123 for the case where the antenna apparatus of FIG. 31 operates at the low-band resonance frequency f1 is small. FIG. 35 is a diagram showing a current path for the case where the antenna apparatus of FIG. 31 operates at the high-band resonance frequency f2. In this case, electromagnetic coupling between the radiators 121 and 123 is small as in the case of FIG. 33.

### Third Embodiment

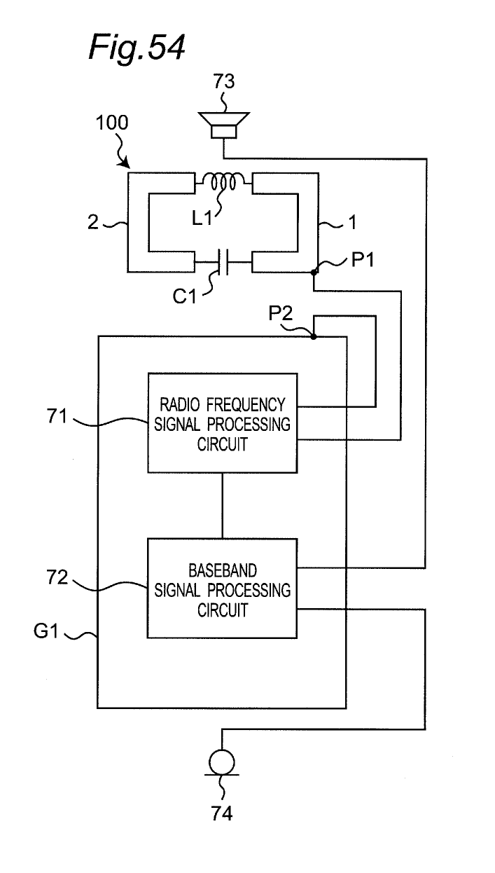

FIG. 54 is a block diagram showing a configuration of a wireless communication apparatus according to a third embodiment of the present invention, the wireless communication apparatus being provided with an antenna apparatus of FIG. 1. The wireless communication apparatus according to the embodiment of the present invention may be configured as, for example, a mobile phone as shown in FIG. 54. The wireless communication apparatus of FIG. 54 is provided with an antenna apparatus of FIG. 1, a radio frequency signal processing circuit 71, a baseband signal processing circuit 72 connected to the radio frequency signal processing circuit 71, and a speaker 73 and a microphone 74 which are connected to the baseband signal processing circuit 72. A feed point P1 of a radiator 100 and a connecting point P2 of a ground conductor G1 of the antenna apparatus are connected to the radio frequency signal processing circuit 71, instead of a signal source Q1 of FIG. 1.

According to the wireless communication apparatus of the present embodiment, it is possible to effectively achieve dual-band operation and reduce size of the wireless communication apparatus, by using the radiator 100 operable in one of the loop antenna mode and the monopole antenna mode depending on the operating frequency.

The embodiments and modified embodiments described above may be combined with each other.

### First Implementation Example

Simulation results for the antenna apparatuses according to the first embodiments will be described below. The software used for the simulations was “CST Microwave Studio”, and a transient analysis was performed using this software. A point at which reflection energy at the feed point is −50 dB or less with respect to input energy was used as a threshold for determining convergence. A portion where a current flows strongly was finely modeled using the sub-mesh method.

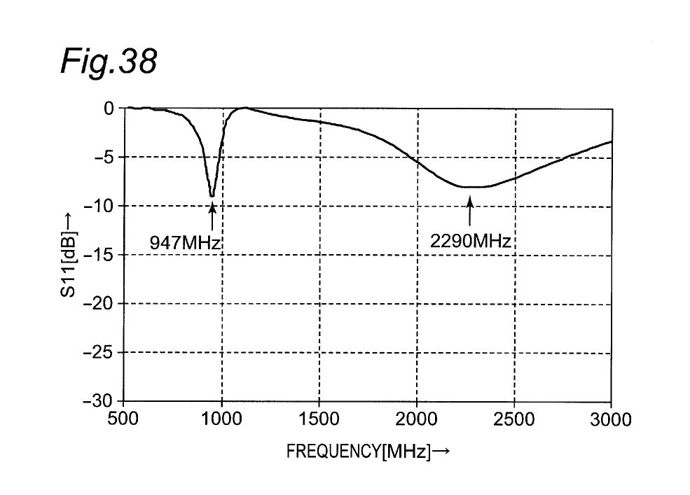

FIG. 36 is a schematic diagram showing an antenna apparatus according to a first implementation example of the first embodiment of the present invention. FIG. 37 is a top view showing a detailed configuration of a radiator 100 of the antenna apparatus of FIG. 36. A capacitor C1 having a capacitance of 0.5 pF was used, and an inductor L1 having an inductance of 4 nH was used. FIG. 38 is a graph showing a frequency characteristic of an S parameter S11 indicative of the reflection coefficient of the antenna apparatus of FIG. 36. According to FIG. 38, it can be seen that the reflection coefficient drops at the low-band resonance frequency f1=947 MHz and at the high-band resonance frequency f2=2290 MHz, thus achieving dual-band operation.

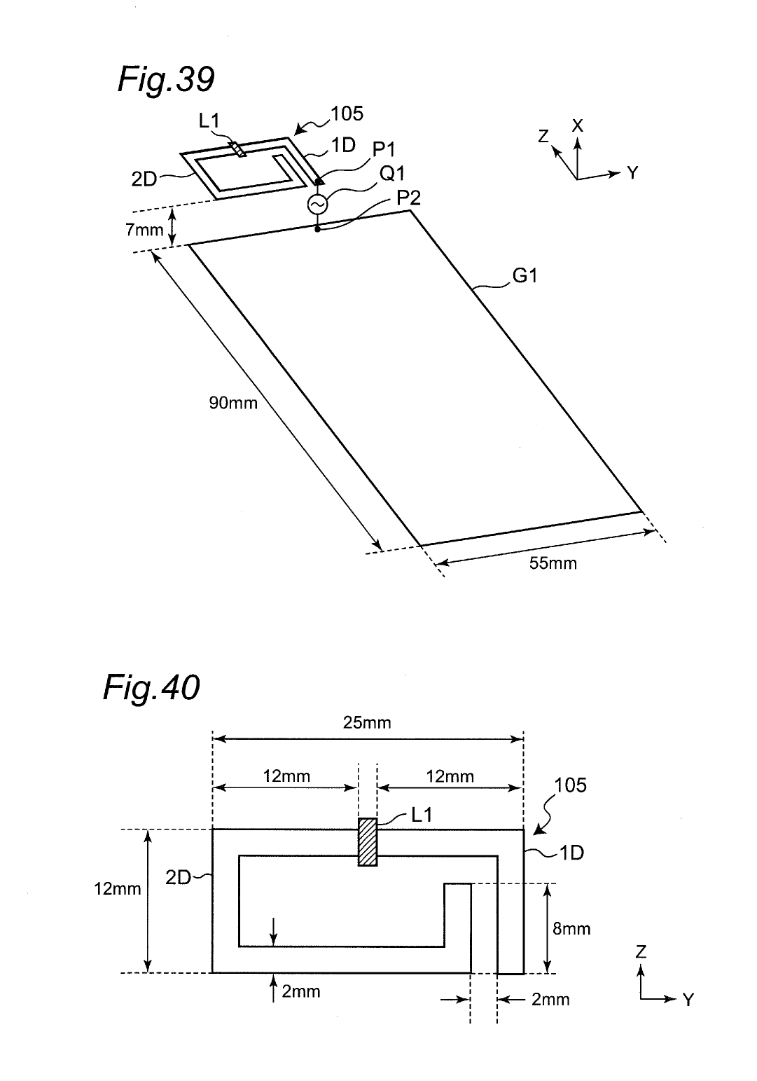

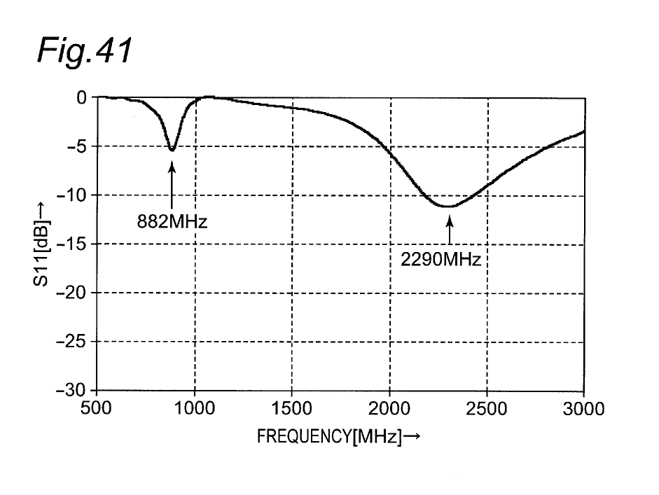

FIG. 39 is a schematic diagram showing an antenna apparatus according to a second implementation example of the first embodiment of the present invention. FIG. 40 is a top view showing a detailed configuration of a radiator 105 of the antenna apparatus of FIG. 39. A capacitor is formed by portions of radiation conductors 1 and 2 close to each other. An inductor L1 having an inductance of 4 nH was used. FIG. 41 is a graph showing a frequency characteristic of an S parameter S11 indicative of the reflection coefficient of the antenna apparatus of FIG. 39. According to FIG. 41, it can be seen that even when a capacitor is formed by portions of the radiation conductors 1 and 2 close to each other, the reflection coefficient drops at the low-band resonance frequency f1=882 MHz and at the high-band resonance frequency f2=2290 MHz, thus achieving dual-band operation.

### Second Implementation Example

Simulation results for antenna apparatuses according to the second embodiment will be described below.

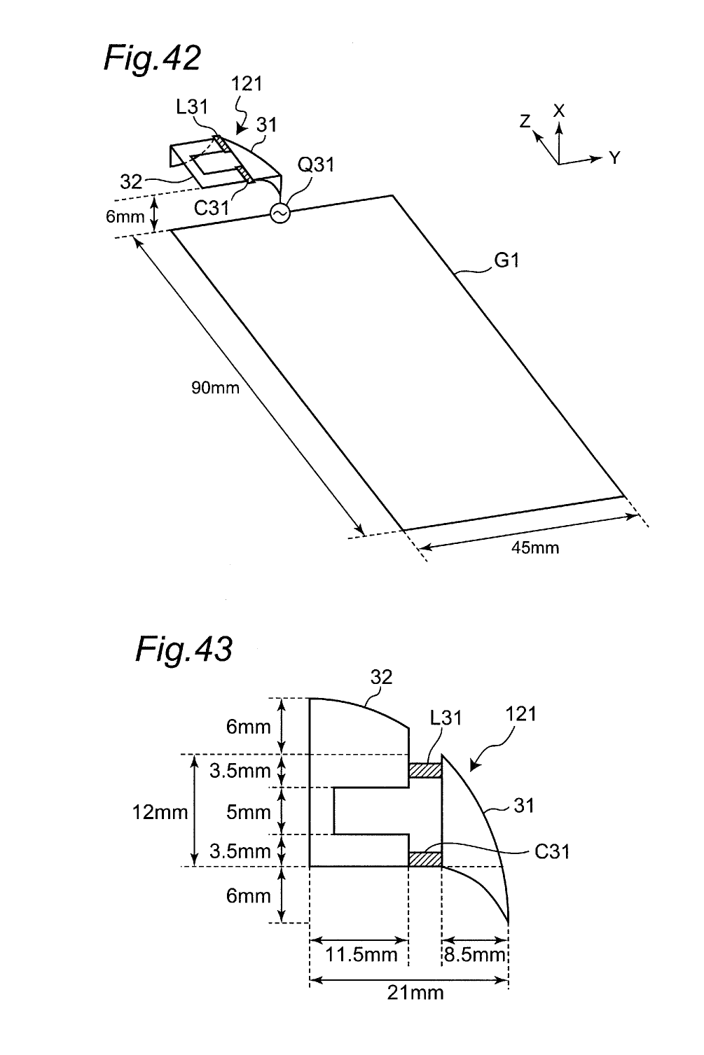

First, for the purpose of comparison, an antenna apparatus having only one of the radiators 121 and 122 of FIG. 28 (i.e., an antenna apparatus of the first embodiment) is shown. FIG. 42 is a schematic diagram showing an antenna apparatus according to a third implementation example of the first embodiment of the present invention. FIG. 43 is a development view showing a detailed configuration of a radiator 121 of the antenna apparatus of FIG. 42. For the purpose of size reduction, radiation conductors 31 and 32 are bent at the positions of dotted lines A1 to A4 on the radiation conductors 31 and 32 of FIG. 28. In FIG. 42, for ease of illustration, a feed point P31, a connecting point P32, and a signal source Q31 are collectively represented by the reference sign of the signal source Q31. A capacitor C1 having a capacitance of 2 pF was used. An inductor L1 having an inductance of 1.5 nH was used.

FIG. 44 is a schematic diagram showing an antenna apparatus according to a first implementation example of the second embodiment of the present invention. The antenna apparatus of FIG. 44 corresponds to the antenna apparatus of FIG. 28. A radiator 121 of FIG. 44 is configured in a manner similar to that of the radiator 121 of FIG. 42. A radiator 122 is configured symmetrically with respect to the radiator 121. FIG. 45 is a schematic diagram showing an antenna apparatus according to a second implementation example of the second embodiment of the present invention. The antenna apparatus of FIG. 45 corresponds to the antenna apparatus of FIG. 31. The antenna apparatus of FIG. 45 is configured in a manner similar to that of the antenna apparatus of FIG. 44, except that the positions of a capacitor C32 and an inductor L32 of a radiator 123 are opposite to those of a capacitor C32 and an inductor L32 of the radiator 122.

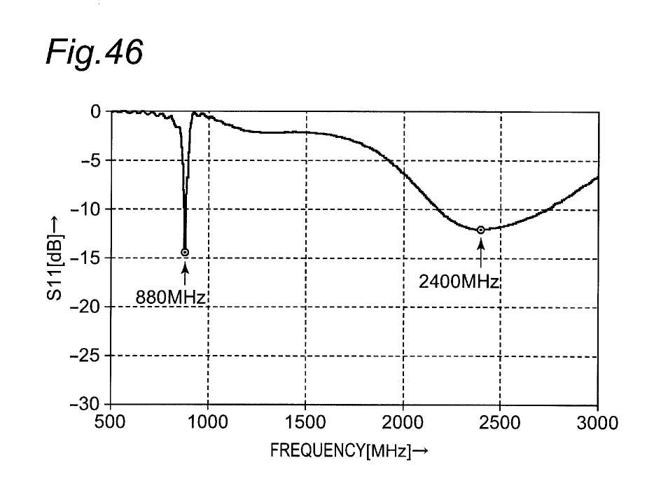

FIG. 46 is a graph showing a frequency characteristic of an S parameter S11 indicative of the reflection coefficient of the antenna apparatus of FIG. 42. According to FIG. 46, it can be seen that the reflection coefficient is −14.4 dB at the low-band resonance frequency f1=880 MHz, and −12.1 dB at the high-band resonance frequency f2=2400 MHz, thus achieving dual-band operation.

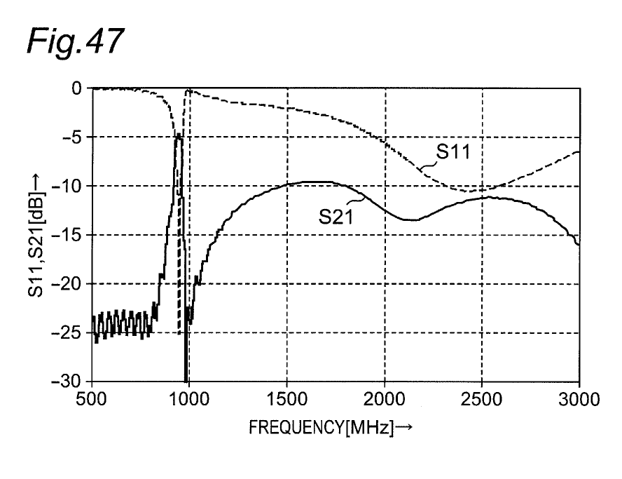

FIG. 47 is a graph showing the frequency characteristics of S parameters S11 and S21 indicative of the reflection coefficient and transmission coefficient of the antenna apparatus of FIG. 44. At the high-band resonance frequency f2=2400 MHz, both the reflection coefficient and the transmission coefficient are low. On the other hand, at the low-band resonance frequency f1=870 MHz, although the reflection coefficient is low, the transmission coefficient is higher than −5 dB due to the electromagnetic coupling between the radiators 121 and 122.

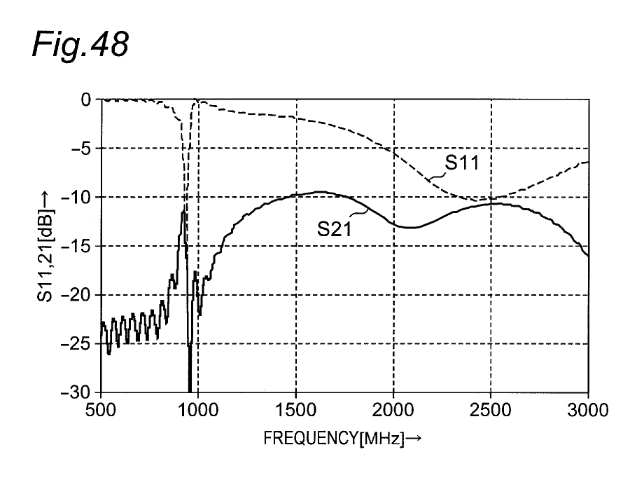

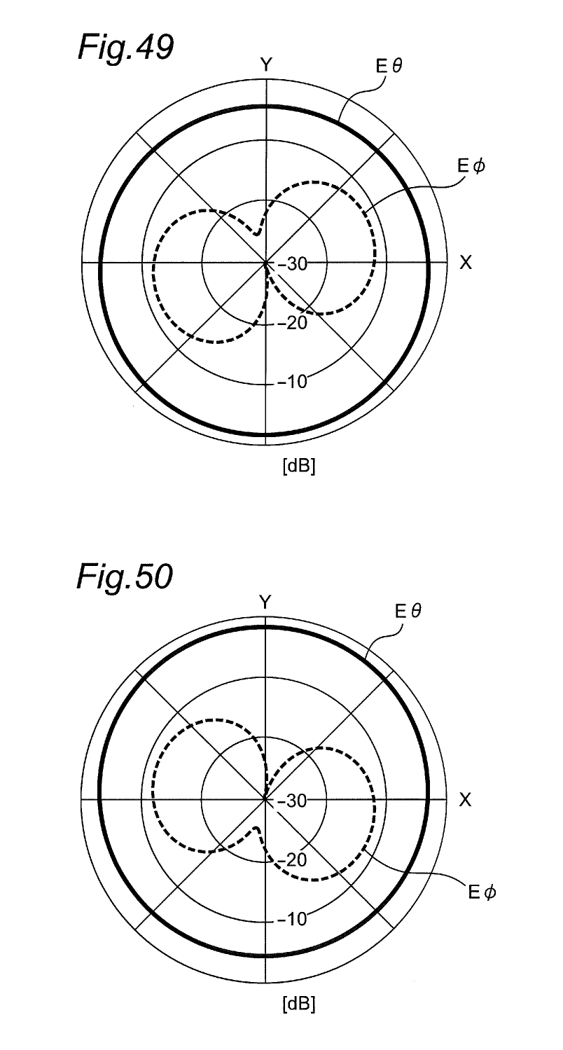

FIG. 48 is a graph showing the frequency characteristics of S parameters S11 and S21 indicative of the reflection coefficient and transmission coefficient of the antenna apparatus of FIG. 45. Since the capacitors and the inductors are disposed asymmetrically between the radiators 121 and 123, it is possible to reduce the electromagnetic coupling between the radiators 121 and 123 for the case where the antenna apparatus operates at the low-band resonance frequency f1. Even at the low-band resonance frequency f1=870 MHz, the transmission coefficient is below −10 dB. Therefore, the antenna apparatus of FIG. 45 achieves a low reflection coefficient and a low transmission coefficient at both the low-band resonance frequency f1 and the high-band resonance frequency f2, thus effectively achieving dual-band operation.

FIG. 49 is a radiation pattern diagram of the radiator 121 on the −Y side for the case where the antenna apparatus of FIG. 44 operates at the low-band resonance frequency f1, and FIG. 50 is a radiation pattern diagram of the radiator 122 on the +Y side. The low-band resonance frequency f1 was 870 MHz. According to FIGS. 49 and 50, it can be seen that the XY plane (Eθ plane) is substantially omnidirectional.

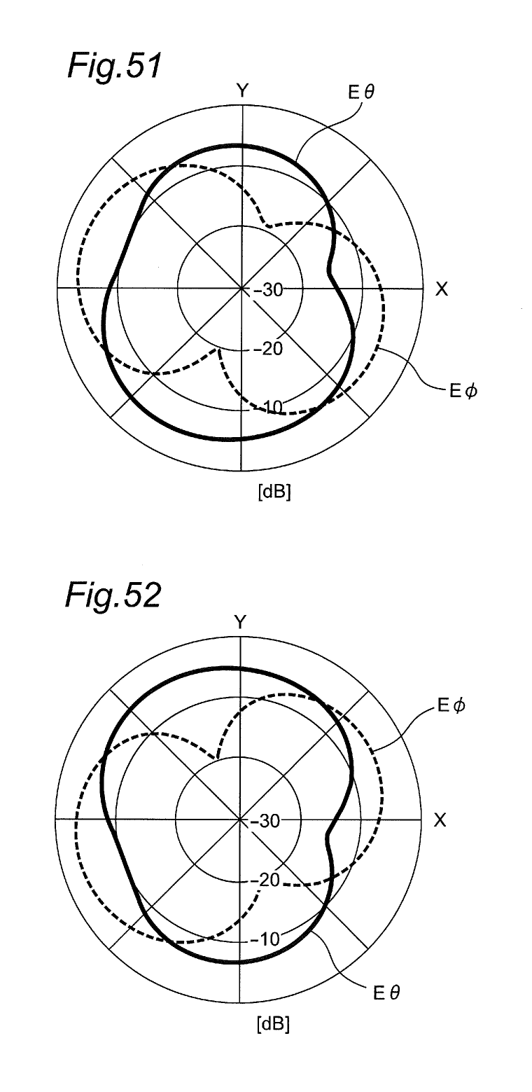

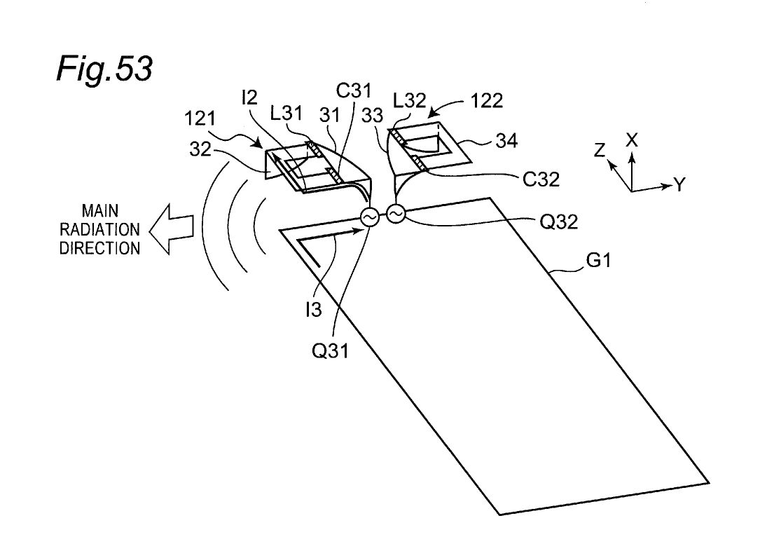

FIG. 51 is a radiation pattern diagram of the radiator 121 on the −Y side for the case where the antenna apparatus of FIG. 44 operates at the high-band resonance frequency f2, and FIG. 52 is a radiation pattern diagram of the radiator 122 on the +Y side. The high-band resonance frequency f2 was 2400 MHz. FIG. 53 is a diagram for illustrating a main radiation direction for the case where the antenna apparatus of FIG. 44 operates at the high-band resonance frequency f2. Considering the case in which only a signal source Q31 operates, since currents are concentrated between a ground conductor G1 and a radiation conductor 32 as shown in FIG. 53, the main radiation direction is opposite to the direction in which the radiator 122 is located. Thus, it is possible to achieve efficient radiation, and reduce the correlation between signals to be transmitted or received through the radiators 121 and 122. When the antenna apparatus operates at the high-band resonance frequency f2, the current on the radiator 121 flows mainly in the −Y direction as shown in FIG. 53, and similarly, the current on the radiator 122 flows mainly in the +Y direction. Thus, as shown in FIG. 47, the reflection coefficient and the transmission coefficient decrease. According to FIGS. 49 and 50, the main radiation direction of the radiator 121 is the −Y direction, and the main radiation direction of the radiator 122 is the +Y direction.

The positions at which radiation conductors are bent, and the number of such positions are not limited to those shown in FIG. 42, etc. The size of the antenna apparatus can be reduced by bending a radiation conductor at at least one position. In addition, when the antenna apparatus operates at the high-band resonance frequency f2, a current I2 may not flow to the position of the inductor L31 or to an edge of the radiation conductor 32 depending on the frequency, and may flow to a certain position on the radiation conductor 32, e.g., to the position at which the radiation conductor 32 is bent, as shown in FIG. 53.

### INDUSTRIAL APPLICABILITY

As described above, antenna apparatuses of the present invention are operable in multiple bands, while having a simple and small configuration. In addition, when the antenna apparatus of the present invention includes a plurality of radiators, the antenna apparatus has low coupling between antenna elements, and thus, is operable to simultaneously transmit or receive a plurality of radio signals.

The antenna apparatuses of the present invention and wireless communication apparatuses using the antenna apparatuses can be implemented as, for example, mobile phones, wireless LAN apparatuses, PDAs, etc. The antenna apparatuses can be mounted on, for example, wireless communication apparatuses for performing MIMO communication. In addition to MIMO, the antenna apparatuses can also be mounted on (multi-application) array antenna apparatuses capable of simultaneously performing communications for a plurality of applications, such as adaptive array antennas, maximal-ratio combining diversity antennas, and phased-array antennas.

### REFERENCES SIGNS LIST

1, 1A to 1H, 2, 2A to 2H, 3, 3A, 11, 12, 21, 22, and 31 to 34: RADIATION CONDUCTOR,
71: RADIO FREQUENCY SIGNAL PROCESSING CIRCUIT,
72: BASEBAND SIGNAL PROCESSING CIRCUIT,
73: SPEAKER,
74: MICROPHONE,
100 to 112, 100A to 100D, and 121 to 123: RADIATOR,
B1: DIELECTRIC SUBSTRATE,
C1 to C6, C11, C21, C31, and C32: CAPACITOR,
G1: GROUND CONDUCTOR,
L1 to L5, L11, L21, L31, and L32: INDUCTOR,
P1, P11, P21, P31, and P33: FEED POINT,
P2, P32, and P34: CONNECTING POINT,
Q1, Q21, Q31, and Q32: SIGNAL SOURCE, and
S1: STRIP CONDUCTOR.

1-14. (canceled)

15. An antenna apparatus comprising at least one radiator,
wherein each of the at least one radiator comprises:
a looped radiation conductor;
at least one capacitor inserted at at least one position along a loop of the radiation conductor;
at least one inductor inserted at at least one position along the loop of the radiation conductor, the position of the inductor being different from the position of the capacitor; and
a feed point provided on the radiation conductor, and
wherein each of the at least one radiator is configured such that:
a first portion of the radiator including the inductor and the capacitor and being along the loop of the radiation conductor resonates at a first frequency; and
a second portion of the radiator including a section along the loop of the radiation conductor resonates at a second frequency higher than the first frequency, the section including the capacitor but not including the inductor, and the section extending between the feed point and the inductor,
wherein the antenna apparatus further comprises a ground conductor,
wherein the capacitor and the inductor of each of the at least one radiator are provided along the loop of the radiation conductor and at a portion where the radiation conductor and the ground conductor are close to each other, and
wherein the feed point is provided between the capacitor and the inductor.

16. The antenna apparatus as claimed in claim 15,
wherein the radiation conductor includes a first radiation conductor and a second radiation conductor, and
wherein the capacitor is formed by a capacitance formed between the first and second radiation conductors.

17. The antenna apparatus as claimed in claim 15,
wherein the inductor is made of a strip conductor.

18. The antenna apparatus as claimed in claim 15,
wherein the inductor is made of a meander conductor.

19. The antenna apparatus as claimed in claim 15, comprising a printed circuit board, the printed circuit board comprising the ground conductor, and a feed line connected to the feed point,
wherein the radiator is formed on the printed circuit board.

20. The antenna apparatus as claimed in claim 15,
wherein the antenna apparatus is a dipole antenna including at least a pair of radiators.

21. The antenna apparatus as claimed in claim 15, comprising a plurality of radiators,
wherein the plurality of radiators have a plurality of different first frequencies and a plurality of different second frequencies, respectively.

22. The antenna apparatus as claimed in claim 15,
wherein the radiation conductor is bent at at least one position.

23. The antenna apparatus as claimed in claim 15, comprising a plurality of radiators connected to different signal sources.

24. The antenna apparatus as claimed in claim 23, comprising a first radiator and a second radiator that have radiation conductors configured symmetrically with respect to a reference axis,
wherein feed points of the first and second radiators are provided at positions symmetric with respect to the reference axis, and
wherein the radiation conductors of the first and second radiators are shaped such that a distance between the first and second radiators gradually increases as a distance from the feed points of the first and second radiators along the reference axis increases.

25. The antenna apparatus as claimed in claim 23, comprising a first radiator and a second radiator,
wherein loops of radiation conductors of the first and second radiators are configured substantially symmetrically with respect to a reference axis, and
wherein, when proceeding along the symmetric loops of the radiation conductors of the first and second radiators in corresponding directions starting from the respective feed points, the first radiator is configured such that the feed point, the inductor, and the capacitor are located in this order, and the second radiator is configured such that the feed point, the capacitor, and the inductor are located in this order.

26. A wireless communication apparatus comprising an antenna apparatus, the antenna apparatus comprising at least one radiator,
wherein each of the at least one radiator comprises:
a looped radiation conductor;
at least one capacitor inserted at at least one position along a loop of the radiation conductor;
at least one inductor inserted at at least one position along the loop of the radiation conductor, the position of the inductor being different from the position of the capacitor; and
a feed point provided on the radiation conductor, and
wherein each of the at least one radiator is configured such that:
a first portion of the radiator including the inductor and the capacitor and being along the loop of the radiation conductor resonates at a first frequency; and
a second portion of the radiator including a section along the loop of the radiation conductor resonates at a second frequency higher than the first frequency, the section including the capacitor but not including the inductor, and the section extending between the feed point and the inductor,
wherein the antenna apparatus further comprises a ground conductor,
wherein the capacitor and the inductor of each of the at least one radiator are provided along the loop of the radiation conductor and at a portion where the radiation conductor and the ground conductor are close to each other, and
wherein the feed point is provided between the capacitor and the inductor.
